(19) United States
(12) Patent Application Publication
(10) Pub. No.: US 2012/0212987 A1
(43) Pub. Date: Aug. 23, 2012

(54) POWER SUPPLY AND POWER CONTROL CIRCUITRY

(75) Inventors: Richard D. Weir, Cedar Park, TX (US); Alexander W. Bernstein, Austin, TX (US)

(73) Assignee: EESTOR, INC., Cedar Park, TX (US)

(21) Appl. No.: 13/400,517

(22) Filed: Feb. 20, 2012

Related U.S. Application Data
(60) Provisional application No. 61/444,992, filed on Feb. 21, 2011.

(51) Int. Cl. H02M 7/5387

(52) U.S. Cl. 363/132

(57) ABSTRACT

A power supply can include a storage component or a storage unit including a capacitive element. In an embodiment, the power supply can include an electrical energy storage unit, a transformer, switching elements, and a pulse width modulation unit. In a particular embodiment, the power supply can be configured to provide an output voltage different from the voltage supplied by the electrical energy power storage unit. In another embodiment, the power supply can include storage components having electrodes connect to different printed circuit boards. In still another embodiment, the power supply can include an output anode, an output cathode, and an input electrode connected to the storage component. In a further embodiment, the power supply circuitry can include a transformer, switching elements, a pulse width modulation unit, and an output control units coupled to an output electrode, the pulse width modulation unit, or any combination thereof.

### CROSS-REFERENCE TO RELATED APPLICATION

This application claims priority under 35 U.S.C. §119(e) to U.S. Patent Application No. 61/444,992 entitled “Power Supply And Power Control Circuitry,” by Weir et al., filed Feb. 21, 2011, which is assigned to the current assignee hereof and incorporated herein by reference in its entirety.

### FIELD OF THE DISCLOSURE

This disclosure, in general, relates to capacitive based electrical energy storage units (electrical ESU), methods for manufacturing same, and applications of such electrical ESUs.

### BACKGROUND

There is increasing demand for high energy density electrical energy storage. From consumer devices, such as cell phones and portable electronics, to automobiles, manufactures are seeking to use electricity in a portable form. However, traditional technologies, such as electrochemical batteries and present ultra-capacitors, have lagged behind commercial efficiency and energy storage capacity demands.

For example, with increasing computational power and features in portable electronic devices, increasing demand is placed on the power source. In addition, consumers desire longer power life between recharging, improved rapid charging, and longer useful life, further increasing demands on electrical energy storage technologies. Contradictorily, consumers are demanding greater portability and reduced weight in portable electronics. With conventional storage devices, such as batteries, manufacturers have found that increasing capacity to meet consumer demand for longer device life between charges results in an undesirable increase in weight and production cost.

In a further example, the automobile industry is increasingly turning to electric vehicles or hybrid vehicles that rely on a large amount of electrical energy storage. Here too, manufacturers have been limited by the weight, size, cost, and useful life of conventional battery devices. To increase the electrical energy storage capacity within a vehicle, more batteries are added, which increases the weight of the vehicle, resulting in less efficient and higher cost electric vehicles. Thus, to provide a desired level of efficiency, manufacturers of hybrid and electrical vehicles are limited in the total amount of storage capacity that can be provided to a vehicle. To this point such limits on electric energy storage has provided an unacceptably low travel distance between recharging such vehicles.

As such, an improved electrical energy storage system would be desirable.

### BRIEF DESCRIPTION OF THE DRAWINGS

The present disclosure may be better understood, and its numerous features and advantages made apparent to those skilled in the art by referencing the accompanying drawings.

FIG. 1 includes a flow chart illustrating an exemplary method for preparing an electrical energy storage device.

FIG. 2 includes an illustration of an exemplary system for preparing a dielectric powder.

FIG. 3 includes an illustration of an exemplary reactor for forming a dielectric powder.

FIG. 4 includes an illustration of an exemplary hydrothermal treatment vessel.

FIG. 5 includes an illustration of an exemplary tube furnace.

FIG. 6 includes an illustration of an exemplary system for coating a dielectric powder.

FIG. 7 includes a flow chart illustrating an exemplary method for forming a capacitive element.

FIG. 8, FIG. 9, and FIG. 10 include illustrations of layered cross sections of a capacitive element.

FIG. 11 includes an illustration of a cross section of a capacitive element.

FIG. 12 includes an illustration of an exemplary component.

FIG. 13 includes an illustration of an exemplary electrical energy storage device.

FIG. 14 includes an illustration of an exemplary portable electronic device.

FIG. 15 includes an illustration of an exemplary vehicle.

FIG. 16 includes an illustration of an exemplary tool.

FIG. 17 includes an illustration of an exemplary utility grid power storage and delivery.

FIG. 18 includes an illustration of an exemplary wind and solar power generating plants power stabilization.

FIG. 19 includes an illustration of an exemplary electric vehicle power delivery station.

FIG. 20 includes an illustration of an exemplary uninterruptable power system.

FIG. 21 and FIG. 22 include particle size distributions of exemplary powders.

FIG. 23 includes an SEM image of an exemplary dielectric particulate.

FIG. 24 includes an SEM image of a composite dielectric layer with 8100 times magnification.

FIG. 25 includes an SEM image of a composite dielectric layer with 335 times magnification.

FIG. 26 includes an illustration of an exemplary hot rolling unit.

FIG. 27 includes a block diagram of an exemplary hot rolling process.

FIG. 28 includes a graph of x-ray diffraction analysis data for Example 1.

FIG. 29 includes a graph of x-ray diffraction analysis data for Example 2.

FIG. 30 includes a graph of x-ray diffraction analysis data for Example 3.

FIG. 31 includes an illustration of an exemplary circuit diagram of a converter circuit.

FIG. 32 includes an illustration of analysis data for the relative permittivity of the composition-modified barium titanate powders processed from Example 3.

FIG. 33, FIGS. 34, and 35 include illustrations of exemplary circuits.

FIG. 36, FIG. 37, FIG. 38, and FIG. 39 include illustrations of an exemplary energy storage component.

FIG. 40 includes an illustration of an exemplary assembly of components.

FIG. 41 includes an illustration of an exemplary electrical energy storage unit.

The use of the same reference symbols in different drawings indicates similar or identical items.

### DETAILED DESCRIPTION

In a particular embodiment, an electrical energy storage device which is used to fabricate an electrical ESU includes electrodes separated by a dielectric layer that, for example, includes a composition-modified barium titanate dielectric ceramic powder immersed in a polymer material. The thickness of the dielectric layer can be approximately 10 μm. The electrical energy storage device has a specific energy of at least 450 W·h/kg based on weight or an energy density of at least 750 W·h/L based on volume. The dielectric ceramic particulate has a relative permittivity of at least 60,000. In an example, the dielectric ceramic particulate includes a composition-modified barium titanate. Further, the energy storage device can have a breakdown voltage of at least 500 V/μm, such as at least 1000 V/μm. The electrical energy storage device can have a maximum voltage of at least 1100 volts, such as at least 2000 V.

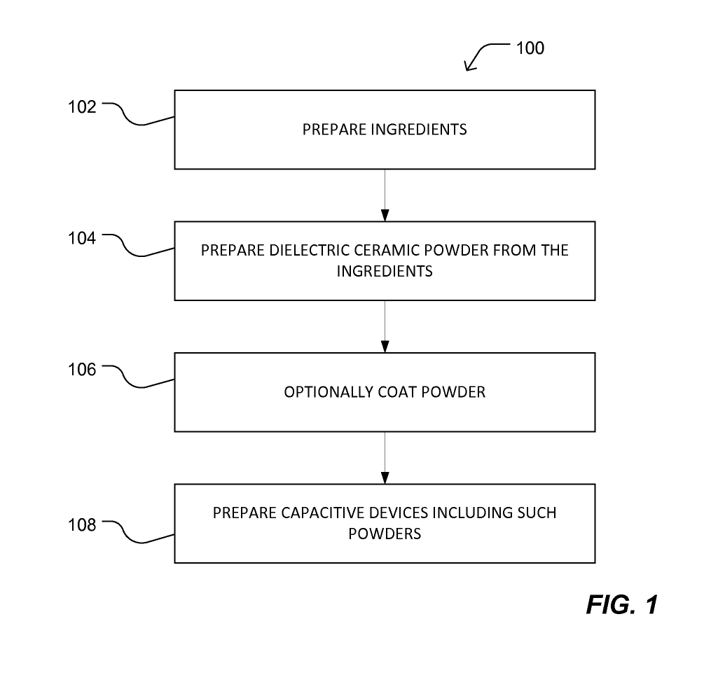

As illustrated in FIG. 1, an exemplary method 100 includes preparing ingredients, as illustrated at 102, preparing a dielectric ceramic powder using the ingredients, as illustrated at 104, optionally coating the dielectric ceramic powder, as illustrated at 106, and preparing capacitive devices including the dielectric ceramic powders, as illustrated at 108. In an example, the dielectric ceramic powders are cubic perovskite materials, such as cubic perovskite composition-modified barium titanate.

High-permittivity calcined composition-modified barium titanate powders can be used to fabricate high-density dielectric devices. Composition-modified barium titanate powders include doped barium titanate dielectric ceramic compositions. An exemplary composition-modified barium titanate dielectric ceramic composition includes a doped barium-calcium-zirconium-titanate of the composition (Ba_{1-α-μ-ν}A_{μ}D_{ν}Ca_{α})[Ti_{1-x-δ-μ′-ν′}Mn_{δ}A′_{μ′}D′_{ν′}Zrₓ]_{z}O₃, where A=Ag or La, A′=Dy, Er, Ho, Y, Yb, or Ga; D=Nd, Pr, Sm, or Gd; D′=Nb, Sn or Mo, 0.10≦x≦0.25; 0≦μ≦0.01, 0≦μ′≦0.01, 0≦ν≦0.01, 0≦ν′≦0.01, 0≦δ≦0.01, and 0.995≦z≦1 and 0≦α≦0.005. These barium-calcium-zirconium-titanate compounds have a perovskite structure of the general composition ABO₃, where one or more of the rare earth metal ions Nd, Pr, Sm, La, Ca, or Gd (having a large ion radius) can be arranged at A-sites, and one or more of the rare earth metal ions Dy, Er, Ho, Yb, the Group 3 ion Y, the Group 13 ion Ga (having a small ion radius), Mn, Sn, or Zr can be arranged at B-sites. As used herein, Group numbers corresponding to columns within the Periodic Table of the Elements use the “New Notation” convention as seen in the CRC Handbook of Chemistry and Physics, 81^{st} Edition (2000), where the Groups are numbered from left to right as 1-18. The perovskite material can include the acceptor ions Ag, Zn, Dy, Er, Ho, Y, Yb, or others or the donor ions Nb, Mo, Nd, Pr, Sm, Gd, or others at lattice sites having a different local symmetry. In a particular example, the composition-modified barium titanate is substantially free of Sr. Donors and acceptors form donor-acceptor complexes within the lattice structure of the barium-calcium-zirconium-titanate. In addition, the perovskite composition-modifier barium titanate can have a cubic crystal structure. Composition-modified barium titanate dielectric ceramic compositions are some of the many types of ceramic compositions that can be fabricated into electrical storage device using the processes and techniques described herein.

### Preparing Ingredients

Returning to FIG. 1, ingredients useful in forming the dielectric ceramic particulate are prepared, as illustrated at 102. For example, the dielectric ceramic particulate can be formed using an aqueous precipitation process. As such, salts and chelates of the constituent metal ions can be prepared to be precipitated to form the dielectric ceramic particulate. In particular, such precursor materials, such as the chelates of the constituent ions, can be prepared individually and separately from each other. Individual preparation limits loss of constituent ions that typically result from competing ion associations that may result in unwanted precipitation of particular ionic species when chelates of different metal ion constituents are formed simultaneously within the same solution. Further, separate formation of individual chelates can be used to more accurately mix ionic species for greater control of dopants and lattice substitutions within resulting precipitated powders. Greater uniformity in lattice substitutions, referred to herein as compositional homogeneity, can lead to uniformity in the cubic perovskite structure of the resulting dielectric ceramic powder, which leads to improved relative permittivity and other properties.

Chelates are used as precursors to one or more of the constituent components of a dielectric ceramic powder. In general, chelation is the formation or presence of bonds (or other attractive interactions) between two or more separate binding sites within the same ligand and a single central atom. A molecular entity in which there is chelation (and the corresponding chemical species) is called a chelate. The terms bidentate (or didentate), tridentate, tetradentate . . . multidentate are often used to indicate the number of potential binding sites of the ligand, at least two of which are used by the ligand in forming a chelate. As used herein, the term “chelate” does not include organometallic compounds, and in particular, does not include metal alkoxides or alkylated metal compounds.

Multiple chelate precursors can be formed separately and used in the process to form ceramic powder. For particular metal ion constituents, the metal ion can be provided as a metal salt or alkoxide. An exemplary salt includes a nitrate, a carbonate, a chloride, or any combination thereof. An exemplary alkoxide includes an ethoxide, a propoxide, an isopropoxide, a butoxide, a tert-butoxide, or any combination thereof. The salt or alkoxide can be reacted in a solution with a chelating agent. Exemplary chelating agents include 2-hydroxypropanoic acid or an alpha-hydroxycarboxylic acid, such as 2-hydroxyethanoic acid, 2-hydroxybutanedioic acid, 2,3-dihydroxybutanedioic acid, 2-hydroxy-1,2,3-propanetricarboxylic acid, 2-hydroxybutanoic acid, 2-hydroxypentanoic acid, 2-hydroxyhexanoic acid, or any combination thereof. In particular, the solution is an aqueous solution. The chelated precursor can be stabilized with a base. For example, the chelate precursor can be stabilized with ammonium hydroxide or tetraalkylammonium hydroxide, such as tetramethylammonium hydroxide or tetraethylammonium hydroxide.

In the context of composition-modified barium titanate, chelates can be formed of one or more constituent metal or oxometal ions. For example, the constituent metal or oxometal ions can include Zr, Mn, Y, Nd, La, Pr, Sm, Gd, Dy, Er, Ho, Yb, Ga, Ag, Dy, Er, Ho, Nb, Mo, Ti, Sn, or any combination thereof. Chelates of such constituent metal or oxometal ions can be formed as described below.

For example, various zirconium compounds can be used as precursors. A convenient zirconium precursor is the hydrolytically stable chelate, and an example includes zirconium(IV) bis(ammonium 2-hydroxypropanato)dihydroxide, also known as zirconium(IV) bis(ammonium lactato)dihydroxide, or [CH₃CH(O—)COONH₄]₂Zr(OH)₂, in aqueous solution, which is stable over the pH range from 6 to 8 up to 100° C. The compound can be prepared from any of the alkoxides of zirconium(IV). Any of these zirconium(IV) alkoxides serve as an intermediate from the zirconium tetrachloride [zirconium(IV) chloride] (ZrCl₄) source in the preparation of other zirconium(IV) compounds. Examples of zirconium(IV) alkoxides include ethoxide [Zr(OCH₂CH₃)₄], propoxide [Zr(OCH₂CH₂CH₃)₄], isopropoxide {Zr[OCH(CH₃)₂]₄}, butoxide [Zr(OCH₂CH₂CH₂CH₃)₄], tert-butoxide {Zr[OC(CH₃)₃]₄}, or any combination thereof. In particular, the zirconium source includes zirconium(IV) isopropoxide, alternatively, tetra-2-propyl zirconate.

Such alkoxides are soluble in alcohols, but hydrolyze in the presence of moisture. By reaction with 2-hydroxypropanoic acid (2-hydroxypropionic acid, lactic acid) [CH₃CH(OH)COOH], 85 wt % in aqueous solution, followed with ammonium hydroxide (NH₄OH), 28 wt % ammonia (NH₃) in water, the water-stable zirconium(IV) chelate is prepared. The ammonium hydroxide can be replaced with tetramethylammonium hydroxide, for example. The byproduct is alcohol from which the zirconium(IV) alkoxide is originally made in the reaction with the zirconium tetrachloride source. Such alcohol is recoverable by fractional distillation, membrane pervaporization, or the like.

Such a zirconium chelate can also be prepared from an aqueous solution of oxozirconium(IV) nitrate (zirconyl nitrate) [ZrO(NO₃)₂] by reaction with 2-hydroxypropanoic acid followed with ammonium hydroxide as described above, resulting in a solution of chelate and ammonium nitrate.

The suitable hydrolytically stable titanium(IV) chelate, such as titanium(IV) bis(ammonium 2-hydroxypropanato)dihydroxide, alternatively, titanium(IV) bis(ammonium lactato)dihydroxide, {[CH₃CH(O—)COONH₄]₂Ti(OH)₂}, is commercially available from, for example, DuPont with trade name Tyzor® LA. It can be prepared from any of the alkoxides of titanium(IV). An exemplary titanium(IV) alkoxides include the following: the methoxide [Ti(OCH₃)₄], the ethoxide [Ti(OCH₂CH₃)₄], the propoxide [Ti(OCH₂CH₂CH₃)₄], the isopropoxide {Ti[OCH(CH₃)₂]₄}, the butoxide [Ti(OCH₂CH₂CH₂CH₃)₄], the tert-butoxide {Ti[OC(CH₃)₃]₄}, or any combination thereof. In particular, the chelate can be titanium(IV) isopropoxide (tetra-2-propyl titanate). By similar preparation methods as those described above for the conversion of an alkoxide of zirconium(IV) to the water-stable chelate, an alkoxide of titanium(IV) can be converted to the water-stable titanium(IV) chelate.

Water-soluble or stable chelates of manganese(II), yttrium(III), lanthanum(III), neodymium(III), and other metal ions can be prepared with the use of 2-hydroxypropanoic acid (lactic acid) and ammonium hydroxide. A tetraalkylammonium hydroxide can be used in place of ammonium hydroxide. Exemplary starting compounds are water-insoluble carbonates of these metal ions, because they more readily react with 2-hydroxypropanoic acid aqueous solution to form water-soluble (ammonium 2-hydroxypropanato) metal-ion chelates. Water-insoluble oxides can also be used as starting compounds, although they are not as quickly reactive.

For example, a manganese chelate can be produced when the manganese(II) carbonate (MnCO₃) is converted to bis(ammonium 2-hydroxypropanato)manganese(II) (i.e., ammonium manganese(II) 2-hydroxypropanate) {Mn[CH₃CH(O—)COONH₄]₂}, as shown in the following reaction equations:

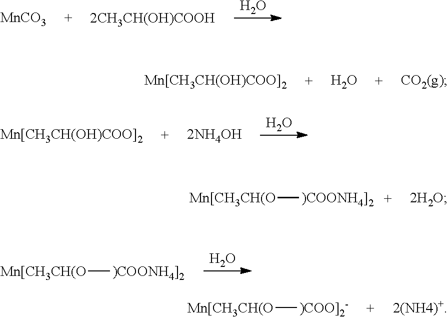

Similarly, a yttrium chelate can be produced by converting yttrium(III) carbonate [Y₂(CO₃)₃] to tris(ammonium 2-hydroxypropanato)yttrium(III) (i.e., ammonium yttrium(III) 2-hydroxypropanate) {Y[CH₃CH(O—)COONH₄]₃} as shown in the following reaction equations:

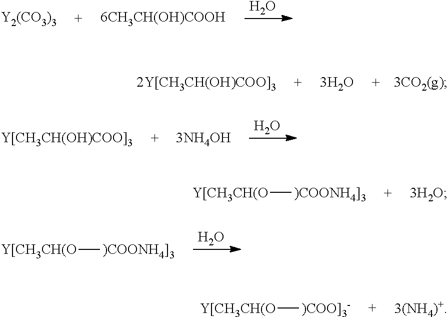

A lanthanum chelate can be produced by converting lanthanum(III) carbonate [La₂(CO₃)₃] to tris(ammonium 2-hydroxypropanato) lanthanum(III) (i.e., ammonium lanthanum(III) 2-hydroxypropanate) {La[CH₃CH(O—)COONH₄]₃} as shown in the following reaction equations:

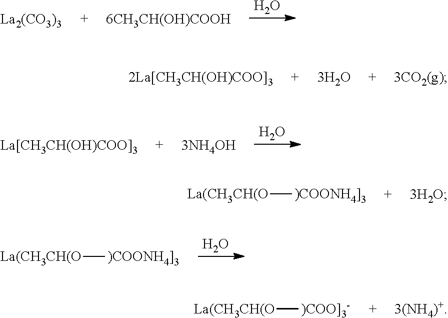

A neodymium chelate can be produced by converting neodymium(III) carbonate [Nd₂(CO₃)₃] to tris(ammonium 2-hydroxypropanato)neodymium(III) (i.e., ammonium neodymium(III) 2-hydroxypropanate) {Nd[CH₃CH(O—)COONH₄]₃} as shown in the following reaction equations:

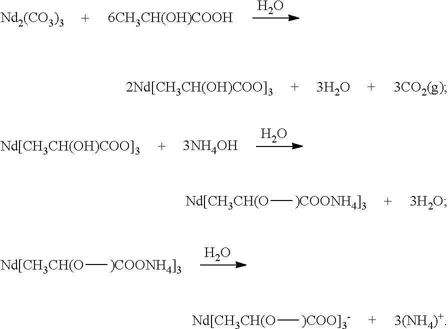

In general, nitrate compounds have the highest solubilities in water, as concentration in moles per liter of solution at 20° C., i.e., molar, and moles per 1000 grams of water, i.e., molal, relative to other salts. Uniquely, there are no water-insoluble nitrates. Since the nitrate anion [(NO₃)⁻] does not interfere with the formation of the chelate, nitrates, too, can be used as starting compounds. The nitrates are readily available commercially. Accordingly, the first reaction of 2-hydroxypropanoic acid with the oxo-metal-ion and metal-ion species as indicated above are as follows:

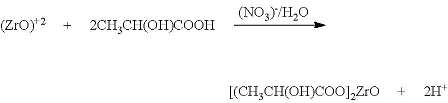

Then with ammonium hydroxide the reaction is:

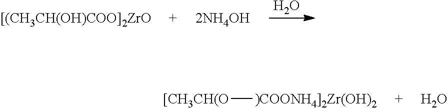

Exemplary reactions of other metal ions with 2-hydroxypropanoic acid include:

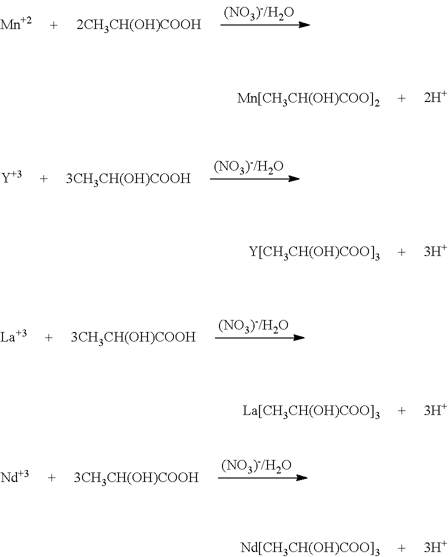

The next-step reactions with ammonium hydroxide are the same as those given above.

When preparing a chelate from an oxometal ion, the metal oxide can be first treated with nitric acid. For example, a starting compound for the preparation of oxozirconium(IV) chelates is an oxozirconium(IV) nitrate aqueous solution with a sufficient concentration of nitric acid to prevent hydrolysis. The nitrate anion [(NO₃)⁻] does not interfere with the formation of the chelate. Among the 2-hydroxycarboxylic acids (alpha-hydroxycarboxylic acids), 2-hydroxy-1,2,3-propanetricarboxylic acid (citric acid) is selected for the oxozironium(IV) chelate for its higher water solubility as concentration in moles per liter of solution at 20° C., i.e., molar, or as moles per 1000 g of water, i.e., molal.

Equations for the preparation of zirconium(IV) (hexaammonium di-2-hydroxy-1,2,3-propanetricarboxylato)dihydroxide, also known as zirconium(IV) (hexaammoniumdicitrato)dihydroxide, from the starting oxozirconium(IV) nitrate [ZrO(NO₃)₂] hydrolytically stabilized by nitric acid (HNO₃) as illustrated below. ZrO(NO₃)₂ is also known as zirconyl nitrate

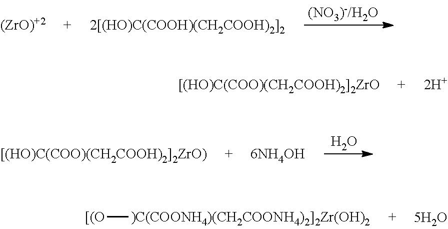

The water-soluble 2-hydroxycarboxylic acid (alpha-hydroxycarboxylic acid) chelates in general are hydrolytically stable over the pH range of 6 to 8. For oxotitanium(IV) and oxozirconium(IV) chelates, gelatinous amorphous hydrous hydroxides are formed above pH 8 and gelatinous amorphous hydrous oxides are formed below pH 6.

In the preparation of the hydrolytically stable chelates, in the reaction of either (1) the titanium(IV) and zirconium(IV) alkoxides, or (2) the metal-ion(II) and metal-ion(III) carbonates or nitrates or of the oxozirconium(IV) nitrate with the 2-hydroxypropanoic acid aqueous solution, the more acidic hydrogen ion of the carboxyl group (COOH) splits off first to form (1) the alcohol from which the alkoxide is made, or (2) water and carbon dioxide for the carbonates, and hydrogen ions for the nitrates. With addition of the base ammonium hydroxide or tetraalkylammonium hydroxide, the onium ions, for example, ammonium ion [(NH₄)⁺], form a salt of the chelate, such as 2-hydroxypropanate chelate. The hydrogen atom of the hydroxyl group (OH) on the carbon atom (the 2-position or alpha-position) adjacent to the carbonyl group (C═O) is relatively acidic, forming a hydrogen ion splitting off with sufficiently basic conditions provided by the addition of the ammonium hydroxide aqueous solution. Additionally, the presence of the hydroxyl group in the 2-position to the carboxylic acid group results in an increased acidity of the latter.

As a chelating agent, 2-hydroxypropanoic acid is a bidentate ligand, since it can bond to a central metal cation via both oxygen atoms of the five-sided ring. Since the outer cage has two or three anion groups, the total negative charge exceeds the positive charge of the central metal cation, and the chelate is an anion with the ammonium cations [(NH₄)⁺] for charge balance. Ammonium ion salts have high water solubilities at neutral and near-neutral pH conditions.

Use of hydrolytically stable chelates in this regard is versatile. In particular, such chelates have applicability to metal ions of the Periodic Table, except those of Groups 1 and perhaps 2, for co-precipitation procedures in the preparation of ceramic powders. Alkali metal ions do not, in general, form complexes and alkaline earth metal ions (Group 2) form rather weak complexes with 2-hydroxypropanoic acid.

In general, water-soluble 2-hydroxycarboxylic acids (alpha-hydroxycarboxylic acids) form considerably stronger complex molecular ions with most metals ions, through bidentate chelation involving both functional donor groups, than do the corresponding simple carboxylic acids. Such chelates provide, in aqueous solution at neutral and near-neutral pH, hydrolytically stable mixtures of such chelates involving two or more metal ions and oxometal ions in any mole ratio of any one to any other. Such stable mixtures lead to compositional homogeneity. In particular, composition homogeneity can be achieved with as many as 5 components, such as at least 7 components or even at least 9 components. Moreover, the ammonium compounds, such as nitrates, 2-hydroxypropanates, etc., thermally decompose and oxidize away as gases, so that they do not have to be washed away from the product precipitate.

In the examples illustrated above, various compounds, solutions, temperature ranges, pH ranges, quantities, weights, and the like are provided for illustration purposes. Those having skill in the art will recognize that some or all of those parameters can be adjusted as desired or necessary. For example, other acids can be used in place of 2-hydroxypropanoic acid as a chelating agent. Alpha-hydroxycarboxylic acids, also known as 2-hydroxycarboxylic acids, having at least the same five-sided ring including the carbonyl group and having the two oxygen atoms of the ring bonding to the central metal ion or oxometal ion can be used and include:
2-hydroxyethanoic acid (i.e., glycolic acid, hydroxyacetic acid) [(OH)CH₂COOH];
2-hydroxybutanedioic acid (i.e., malic acid, hydroxysuccinic acid) [HOOCCH₂CH(OH)COOH];
2,3-dihydroxybutanedioic acid (i.e., tartaric acid) [HOOCCH(OH)CH(OH)COOH];
2-hydroxy-1,2,3-propanetricarboxylic acid (i.e., citric acid)
[(OH)C(COOH) (CH₂COOH)₂];
2-hydroxybutanoic acid [CH₃CH₂CH(OH)COOH];
2-hydroxypentanoic acid [CH₃(CH₂)₂CH(OH)COOH]; and
2-hydroxyhexanoic acid (i.e., 2-hydroxycaproic acid) [CH₃(CH₂)₃CH(OH)COOH].

Such water-soluble chelating agents are also useful in preparing the water-soluble precursors for the co-precipitation procedure. The first four of these chelating agents have higher solubilities in water, similar to that of 2-hydroxypropanoic acid. With increasing length of the carbon chain (the nonpolar part of the molecule), the water solubility generally decreases. Alcohol or water soluble metal ion, such as La, Sn, or Sr, among others, can be formed as a chelate and processes as indicated above to be one of the constituents of a composition-modified barium titanate powder. However, metal ions of Group 1 and some species of Group 2 are generally avoided. In a particular example, the composition-modified barium titanate includes calcium, but is substantially free of Sr.

In the wet-chemical co-precipitation procedure involving the use of water-soluble hydrolytically stable metal-ion and oxometal-ion chelate precursors and a precipitant solution including an ammonium oxalate or tetramethylammonium oxalate and tetramethylammonium hydroxide for the preparation of ceramic powder, it has been discovered that the reactivity is significantly enhanced by increasing the pH of the precipitant sufficiently to result in the range of 8.0 to 12.0 pH for the reaction at the time of mixing of the two solutions, together with increasing the temperature of these two solutions to 95° C. to 99° C.

In particular, the constituents are provided in aqueous solution substantially free of contaminants, for example, having less than 2 ppm of a contaminant metal ion. In an example, the aqueous solution includes less than 1 ppm of sodium or potassium.

### Preparing Dielectric Ceramic Particulate

Returning to FIG. 1, a dielectric ceramic particulate can be prepared using the constituent ingredients, as illustrated at 104. For example, the constituent ingredients can be mixed and precipitated to form intermediate particles that are further treated and calcined to form the composition-modified barium titanate dielectric ceramic particulate. As described in more detail below, the aqueous solution containing the constituent ingredients can be blended in a high turbulence reactor with a blend of a source of hydroxide ions and a source of oxalate ions. For example, the source of hydroxide ions can include tetraalkylammonium hydroxide and the source of oxalate ions can include tetraalkylammonium oxalate. Particles that form as a result of the precipitation in the presence of hydroxyl and oxalate ions are further hydrothermal treated, dried and calcined under specific conditions to provide a composition-modified barium titanate dielectric ceramic particulate having desirable properties, such as breakdown voltage and relative permittivity that is stable over a wide range of temperatures, voltages, and frequencies.

An exemplary process includes providing precursor chelates in a combined solution with other metal or oxometal ion constituents of a ceramic powder, preparing a precipitant solution including tetraalkylammonium hydroxide and an oxalate compound, such as ammonium oxalate or tetraalkylammonium oxalate, combining the combined solution and the precipitant solution to coprecipitate particles, hydrothermally treating the particles, washing and separating the particles, and heat treating the particles to undergo decomposition and calcining.

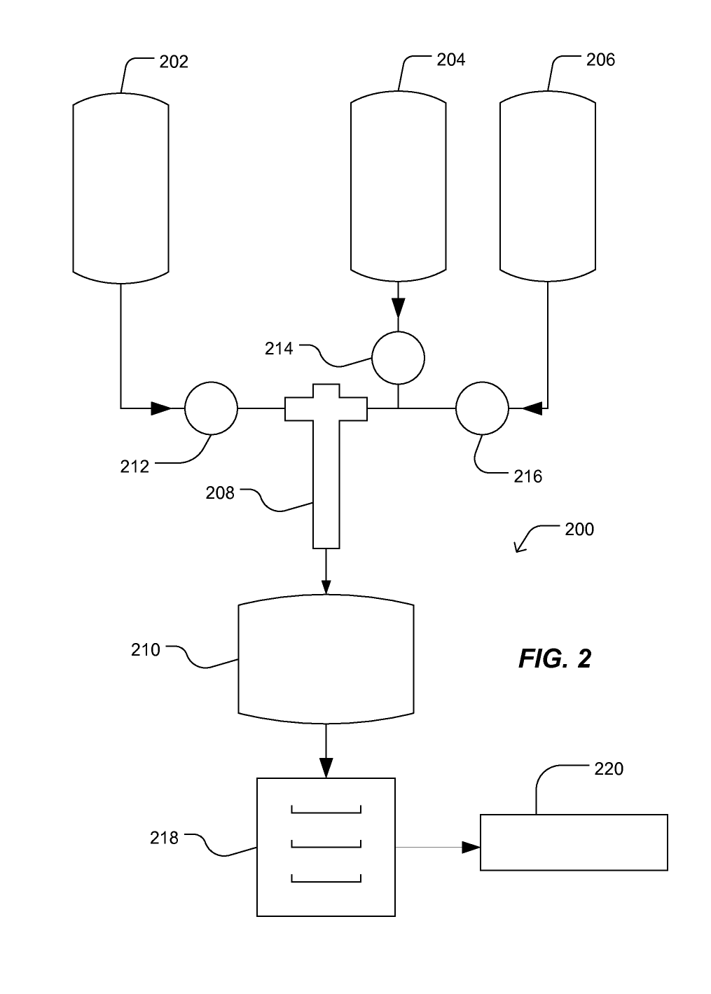

In an exemplary embodiment illustrated in FIG. 2, the system 200 for forming a dielectric particulate includes a reactor 208 and a hydrothermal treatment chamber 210. In addition, the system 200 can include reactant storage vessels 202, 204 or 206, which can be pressurized. Further, the system 200 can include valves 212, 214 or 216. As illustrated, the valves 212, 214 and 216 when active allow the pressurized reactant solutions from storage vessels 202, 204 or 206 to flow into the reactor 208. Products from reactor 208 are directed to the hydrothermal treatment apparatus 210. Subsequently, the products of the hydrothermal treatment apparatus 210 are directed to a particle washer and dryer 218, followed by decomposition and calcining equipment 220.

The reactant storage vessels 202, 204 or 206 include one or more reactants, for example, in the form of reactant solutions. In particular, the reactants can include a metal nitrate, a metal chelate, tetraalkylammonium hydroxide or tetraalkylammonium oxalate, or any combination thereof. The metal nitrate or metal chelate can include a metal ion or oxometal ion including a metal or semi-metal of Groups 1 to 14 of the Periodic Table, the lanthanoid series, or the actinoid series, based on the IUPAC convention. For example, the metal ions can be selected from the group including barium, calcium, titanium, zirconium, yttrium, manganese, neodymium, tin, zinc, vanadium, niobium, tantalum, molybdenum, tungsten, lanthanum, hafnium, chromium, or any combination thereof. In particular, the metal ions include barium, titanium, and at least one of calcium, zirconium, yttrium, manganese, neodymium, tin, zinc, vanadium, niobium, tantalum, molybdenum, tungsten, lanthanum, hafnium, chromium, or any combination thereof. An exemplary metal nitrate includes barium nitrate, calcium nitrate, or a combination thereof. An exemplary metal chelate includes a metal ion or oxometal ion and a chelating agent. In an example, the chelating agent includes a carboxylic acid neutralized with a base. For example, the chelating agent can include a neutralized alpha-hydroxycarboxylic acid. An exemplary alpha-hydroxycarboxylic acid includes 2-hydroxyethanoic acid (glycolic acid), 2-hydroxybutanedioic acid (malic acid), 2,3-dihydroxybutanedioic acid (tartaric acid), 2-hydroxy-1,2,3-propanetricarboxylic acid (citric acid), 2-hydroxybutanoic acid, 2-hydroxypentanoic acid, 2-hydroxyhexanoic acid, or any combination thereof. An exemplary chelating agent is water-soluble 2-hydroxypropanoic acid (i.e., lactic acid) followed by neutralization with the weak-base, such as an ammonium hydroxide aqueous solution. Another exemplary chelating agent is water-soluble 2-hydroxy-1,2,3-propanetricarboxylic acid, i.e., citric acid. The chelating agent can be neutralized with a base, such as ammonium hydroxide (NH₄OH) or tetraalkylammonium hydroxide. The chelated solution can also include a surfactant.

Further, the reactants can include a tetraalkylammonium hydroxide, tetraalkylammonium oxalate or combinations thereof in which the alkyl group includes methyl, ethyl, or propyl groups, or any combination thereof. In particular, the reactants can include a combination of tetramethylammonium hydroxide and tetramethylammonium oxalate.

In one embodiment, at least one, but not all of the precursors are chelates. A solution of the precursors, including Ba(NO₃)₂, Ca(NO₃)₂.4H₂O, Nd(NO₃)₃.6H₂O, Y(NO₃)₃.4H₂O, Mn(CH₃COO)₂.4H₂O, ZrO(NO₃)₂, is formed in deionized water, and separately the [CH₃CH(O—)COONH₄]₂Ti(OH)₂, solution. In this example, the titanium chelate [CH₃CH(O—)COONH₄]₂Ti(OH)₂ can be used. The solution can be mixed ef and heated (e.g., heated to 95° C. to 99° C.). For a particular composition shown by the atom fraction, the proportionate amount in weight percent for each of the metal-ion constituents separated into A and B site constituents is shown in Table 1.

TABLE 1
Exemplary Formulation

| Metal | Atom | | | |
|---|---|---|---|---|
| Element | Fract. | Atomic Wt. | Product | Wt % |
| Ba | 0.9575 | 137.327 | 131.49 | 98.53 |
| Ca | 0.0400 | 40.078 | 1.60 | 1.20 |
| Nd | 0.0025 | 144.240 | 0.36 | 0.27 |
| Total | 1.0000 | | | 100.00 |
| Ti | 0.8150 | 47.867 | 39.01 | 69.92 |
| Zr | 0.1800 | 91.224 | 16.42 | 29.43 |
| Mn | 0.0025 | 54.930 | 0.14 | 0.25 |
| Y | 0.0025 | 88.905 | 0.22 | 0.39 |
| Total | 1.0000 | | | 100.00 |

In particular, barium can form between 90% and 100% of the A site constituents, such as 93% to 98%, or even 94% to 96% of the A site constituents. Calcium can be included in amount, when expresses as a ratio relative to the amount of barium, in a range of 0.01 to 0.1 of the A site constituents, such as a range of 0.02 to 0.08, or even a range of 0.02 to 0.06 of the A site constituents. Other A site constituents can each be included in amounts, when expressed as a ratio relative to the amount of barium, in a range of 0.0005 to 0.01 of the A site constituents, such as a range of 0.001 to 0.006, or even a range of 0.001 to 0.004 of the A site constituents. Titanium can form between 75% and 100% of the B site constituents, such as between 75% and 90% of the B site constituents, or even 78% to 85% of the B site constituents. Zirconium can be included in amounts, when expressed as a ratio relative to the amount of titanium, in a range of 0.05 to 0.4 of the B site constituents, such as a range of 0.1 to 0.3, or a range of 0.15 to 0.25 of the B site constituents. Other B site constituents can each be included in amounts, when expressed as a ratio relative to the amount of titanium, in a range of 0.0005 to 0.01, such as a range of 0.001 to 0.005, or a range of 0.0015 to 0.005 of the B site constituents. Additional A or B site constituents can be used in the above-specified amounts to provide at least 7 total metal constituents, such as at least 8, at least 9, or even at least 10 metal constituents.

The metal-ion constituents that can be used for the co-precipitation of the composition-modified barium titanate powders used in the seven or more (e.g., 9) constituent runs indicated above are identified in the following list: barium, calcium, titanium, zirconium, yttrium, manganese, neodymium, tin, zinc, vanadium, niobium, tantalum, molybdenum, tungsten, lanthanum, hafnium, and chromium, or any combination thereof.

Table 2 illustrates an example composition-modified barium titanate compound formed using the above-described chelate precursors. In this example, the formula weight of the resulting compound is 237.24.

TABLE 2
Precursor Composition

| Precursor | FW | Mol. Frac. | Product | Wt % |
|---|---|---|---|---|
| Ba(NO₃)₂ | 261.43 | 0.4787 | 125.11 | 44.45 |
| Ca(NO₃)₂•4H₂O | 236.15 | 0.0200 | 4.732 | 1.67 |
| Nd[CH₃CH(O—)COONH₄]₃ | 465.57 | 0.00125 | 0.5819 | 0.207 |
| [CH₃CH(O—)COONH₄]₂Ti(OH)₂ | 294.08 | 0.4075 | 119.83 | 42.58 |
| [CH₃CH(O—)COONH₄]₂Zr(OH)₂ | 337.44 | 0.0900 | 30.37 | 10.79 |
| Mn[CH₃CH(O—)COONH₄]₂ | 269.15 | 0.00125 | 0.3364 | 0.119 |
| Y[CH₃CH(O—)COONH₄]₃ | 410.23 | 0.00125 | 0.5128 | 0.182 |
| Total | | | 281.48 | 100.00 |

A separate solution of ammonium oxalate or tetramethylammonium oxalate and tetramethylammonium hydroxide somewhat in excess of the stoichiometric amounts, is made in deionized water and heated to 95° C. to 99° C. with the pH in the 8.0 to 12.0 range, an in particular, about 10.5.

Various wet-chemical powder preparation techniques for composition-modified barium titanate are described below. The methods make use of aqueous solutions for the reactants to form the desired powders by co-precipitation. Furthermore, the approach extends the use of one or more chelates (particularly, water-soluble or water stable) as precursors to several of the component metal ions comprising the constituents of the composition-modified barium titanate. In an example, ammonium oxalate (also known as diammonium ethanedioate) or tetraalkylammonium oxalate, such as tetramethylammonium oxalate (also known as bis(tetramethylammonium) ethanedioate), in combination with tetraalkylammonium hydroxide, such as tetramethylammonium hydroxide, are used as the precipitant solution for the mixture of precursors in aqueous solution.

The volume amount of the precipitant solution can be determined from the molar concentration of the precursor solution, when the specific gravity at 20° C. in addition to the molal concentration is known. Since the oxalate anion is doubly negatively charged and the hydroxide anion (e.g., a tetraalkylammonium hydroxide) is singly negatively charged, as precipitants for a given molar concentration, half as many oxalate anions compared to hydroxide anions can be used for the precipitation reaction with the metal-ion cations. The ammonium oxalate or tetraalkylammonium oxalate in aqueous solution is at neutral or near neutral pH (e.g., 6 to 8 pH), but here the solution is made sufficiently basic with the addition of tetramethylammonium hydroxide to result in a pH in the range of 8.0 to 12.0 pH of the mixed solutions, upon reaction with the neutral or near-neutral pH precursor solution. The pH can be higher depending of the application.

In particular, the precipitant solution includes an oxalate source, such as ammonium oxalate or tetraalkylammonium oxalate, and a hydroxide, such as tetraalkylammonium hydroxide. For example, the solution can include the oxalate source in a mole ratio relative to the hydroxide in a range of 4:1 to 1:2, such as a range of 3:1 to 2:3, a range of 2:1 to 4:5, or a range of 2:1 to 1:1. The average ratio of the 25% solution of tetramethylammonium hydroxide to 25% solution of tetramethylammonium oxalate is respectively 148 grams for every 1000 grams. A suitable temperature range for the formation of aqueous-solution of hydrated oxalate-hydroxide precipitated powders is 95° C. to 99° C.

In an example, oxalate compounds can include ammonium oxalate or tetraalkylammonium oxalate. An exemplary tetraalkylammonium oxalate includes tetramethylammonium oxalate (TMAO), tetraethylammonium oxalate, tetrapropylammonium oxalate, tetrabutylammonium oxalate, or any combination thereof. Ammonium oxalate monohydrate is typically made by the reaction of oxalic acid and ammonium hydroxide in aqueous solution. At pH 7, there is generally no unreacted oxalic acid and ammonium hydroxide. While the ammonium oxalate is typically used at pH 7, it is often provided by manufacturers in the pH 6.0 to 7.0 range. Tetramethylammonium oxalate is currently available and is similarly prepared.

For the case of tetramethylammonium hydroxide [(CH₃)₄NOH] (TMAH), the concentration is typically 25 weight percent in an aqueous solution with a specific gravity at 20° C. of 1.016, corresponding to 3.6570 molal and 2.7865 molar concentrations. At 80° C., the solubility of ammonium oxalate is 1.8051 molal, and since half as many oxalate anions compared to hydroxide anions are used for the precipitation reaction with the metal-ion cations, the solution volumes are essentially equivalent. For the case of tetramethylammonium oxalate the same molal concentration can be selected.

When ammonium oxalate or tetramethylammonium oxalate is present in stoichiometric quantity with 2 to 5 percent excess, even with the addition of tetramethylammonium hydroxide to increase the pH sufficiently to result in a pH in the range of 8.0 to 12.0, such as a pH of 9 to 12, or even a pH of 10 to 12, at the time of reaction of the precursor and precipitant solutions, and at 95° C. to 99° C., partial-crystalline hydrated oxalate-hydroxides are formed instead of gelatinous hydrous hydroxides and/or oxides. Interestingly, the 2-hydroxycarboxylic acids and the oxalate anion are bidentate with two oxygen bonding sites within the ligand to the central metal or oxometal ion, and also are both five-sided rings.

The pH of the ammonium oxalate or tetramethylammonium oxalate solution is raised from about 7 to a sufficiently high value so that upon mixing of the two reactant streams the pH is at that point in the range of 8 to 12, such as 9 to 12, or, in particular, about 10.6, where the precipitation occurs to completion at 95° C. to 99° C. for the metal and oxometal ion constituents in the solution. The pH is adjusted by the addition of a strong base selected from among the tetraalkylammonium hydroxides, such as tetramethylammonium hydroxide [(CH₃)₄NOH], to the point in the pH range of 8 to 12, such as 9 to 11, or, in particular, about 10.6, where precipitation at 95° C. to 99° C. occurs to completion of the metal and oxometal ion constituents.

In the preparation of the metal-ion and oxometal-ion precursor solutions where both 2-hydroxypropanoic acid (lactic acid) [CH₃CH(OH)COOH] and 2-hydroxy-1,2,3-propanetricarboxylic acid (citric acid) [(OH)C(COOH) (CH₂COOH)₂] have been used as the chelating agent, the latter may be selected because of higher solubilities in water, as concentration in moles per liter of solution at 20° C., i.e., molar, and moles per 1000 grams of water, i.e., molal, are obtained.

The advantages of wet-chemical methods in the preparation of powders for fabricating oxide ceramics of technical significance are enlarged in scope with the use, as precursors, of hydrolytically stable chelates of metal ions or oxometal ions at neutral and near-neutral pH, and with the use, as the precipitating agent, of ammonium oxalate or tetramethylammonium oxalate and tetramethylammonium hydroxide aqueous solution sufficient to result in a pH in the range of 8.0 to 12.0 when the precursor and precipitant solutions are reacted.

Returning to FIG. 2, the reactants are pumped into the reactor 208 using pumps 212, 214, or 216. An alternative method of motivating the reactants into the reactor includes pressurizing the storage vessels 202, 204, or 206. In particular, the reactants are pumped or high pressure delivered through ports on the reactor that are coaxial and directly opposite, causing the reactant streams to directly impact one another. Control of flow rate can be implemented using flow meters and control systems (not illustrated).

The reactor 208 is configured to provide a turbulence intensity of at least 1.5×10⁷ cm/s³ at operating conditions. Turbulence intensity is defined as the product of a dimensionless constant (k) characteristic of the mixing device (approximately 1.0 for the present reactor) and the cube of the velocity of the combined fluid streams in the mixer, divided by the square of the inside diameter of the mixer. In an example, the operating conditions include a reaction tube velocity of at least 500 cm/s, such as at least 1000 cm/s, at least 1500 cm/s, or even at least 2000 cm/s. In a particular example, the reaction tube velocity is not greater than 20,000 cm/s, such as not greater than 15,000 cm/s, or even not greater than 10,000 cm/s. For example, the reactor 208 can include a reaction tube having a closed end and an open end. The injection ports can be disposed proximal to the closed end. Further, the ports are coaxial with and directly opposite one another. Once mixed, the reactants flow through the reactor 208 from the closed end towards the open end for a period of at least 50 milliseconds and are directed to a hydrothermal treatment chamber 210. Longer or shorter solution resident times can be used depending on other parameters selected.

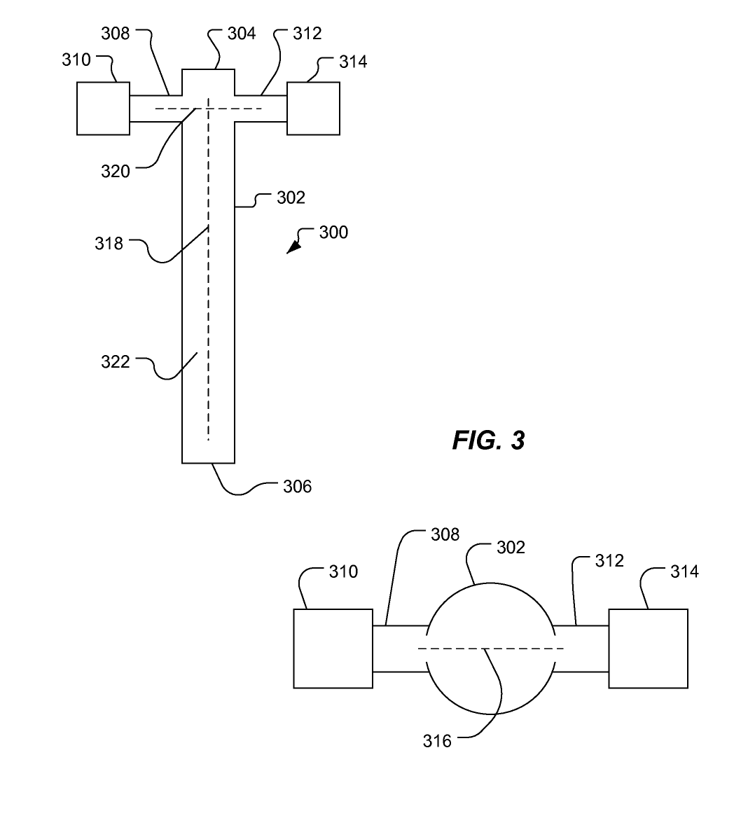

As stated above, the reactor is configured to perform the reaction at turbulence intensity of at least 1.5×10⁷ cm/s³. In a particular embodiment, such high turbulence intensity is achieved using a tubular reactor with coaxial and directly opposite injection. For example, a reactor 300 illustrated in FIG. 3 includes a cylindrical structure or tubular reactor 302 and injection ports 308 and 312. The tubular reactor 302 includes a closed end 304 and an open end 306 and a lumen 322 extending from the closed end 304 through the open end 306. In particular, the closed end 304 can be formed of a weld cap or screw cap. The injection ports 308 and 312 are disposed close to the closed end 304. Each of the injection ports 308 and 312 can include a connector 310 or 314 to which fluid conduits (not illustrated) carrying the reactant solutions are attached. Alternatively, the connector 310 or 314 can include a valve, such as a metering valve. For example, the metering valve can be a needle valve or metering valve available from Parker Instrumentation.

The injection ports 308 and 312 are disposed proximal to the closed end 304. In addition, the ports 308 and 312 are disposed at approximately the same axial location along an axis 318 of the tubular reactor 302. In a further example, the ports 308 and 312 are located within the same cross-sectional plane 320 perpendicular to the axis 318.

In addition, the ports 308 and 312 when viewed in the cross-section illustrated in FIG. 3 are positioned directly opposite one another. Within the plane 320, the ports 308 and 312 direct streams in an approximate line 316 directly toward one another. In particular, relative to port 308 within the plane 320, port 312 directs fluid in a direction approximately 180° opposite, such as within 10° of 180°, or within 5° of 180° or a lower angle of deviation. In alternative embodiments, the reactants can be injected through more than two ports. For example, the reactants can be injected into three or four ports. In such an example, at least two of the ports can be positioned coaxially and direct fluids in approximately opposite directions. Alternatively, the ports can be disposed within the same plane and can be positioned to direct fluids in evenly distributed directions. For example, in a three port configuration, each port can have approximately the same axial position along a reactor tube (e.g., within the same plane), directing fluid in directions that are 120° different from adjacent ports. In a four port configuration, the directions can be 90° different.

In an example, each of the ports has a Cᵥ (according to the US measurement system) of not greater than 0.5, such as not greater than 0.1. In a particular example, the Cᵥ ratio, defined as the ratio of the Cᵥ for the second stream divided by the Cᵥ of the first stream is in a range of 1.0 to 0.1, such as in a range of 0.8 to 0.15, or even a range of 0.5 to 0.15. Further, the pressure drop when in use across ports 208 or 212 can be at least 20 psi, such as at least 40 psi, at least 60 psi, at least 80 psi, or even at least 100 psi. In an example, the pressure drop is not greater than 500 psi.

The tubular reactor 302 can be configured to provide both a desirable turbulence, as well as, a desirable residence time for the reaction. For example, for a total flow rate on the order of 10 to 15 liters per minute, the inner diameter of the tubular reactor 302 can be in a range of 0.2 to 2 cm, such as a range of 0.3 cm to 1.5 cm, or even a range of 0.3 cm to 1.05 cm. In particular, the diameter can be greater than 0.3 cm and less than 1 cm. The length of the tubular reactor 302 can be at least 20 cm and may be not greater than 500 cm. In an example, the length is at least 40 cm, such as at least 70 cm, or even at least 100 cm. In particular, the length of the reactor can be in a range of 100 cm to 200 cm, such as a range of 125 cm to 200 cm, or even a range of 150 cm to 200 cm. While the diameter and length can be influenced by the flow rate, the ratio of the diameter to the length may be not greater than 0.1, such as not greater than 0.08, not greater than 0.05, or even not greater than 0.01. In particular, the ratio may be not greater than 0.005.

In an embodiment, the reactor 300 is configured to provide a high turbulence intensity, defined as the product of a dimensionless constant (k) characteristic of the mixing device (approximately 1.0 for the present reactor) and the cube of the velocity of the combined fluid streams in the mixer, divided by the square of the inside diameter of the mixer. For example, the turbulence intensity can be at least 1.5×10⁷ cm/s³, such as at least 10⁸ cm/s³, at least 10⁹ cm/s³, at least 10¹⁰ cm/s³, or even at least 5×10¹⁰ cm/s³. In general, the turbulence intensity is not greater than 10²⁰ cm/s³. In addition, the tubular reactor can provide an average Reynolds number of at least 20,000. For example, the Reynolds number can be at least 40,000, such as at least 60,000, at least 70,000, or even at least 75,000. In an example, the Reynolds number is not greater than 200,000.

The reactor can be configured for a residence time of at least 50 milliseconds, such as at least 70 milliseconds, or even at least 80 milliseconds. In an example, the reactor is configured for a residence time of not greater than 1 second.

In a particular embodiment, a method for forming dielectric particulate includes injecting reactant solutions into a tubular reactor. One of the reactant solutions can include metal ions in the form of nitrates or chelates. In particular, metal nitrates can include barium nitrate. In addition, the metal nitrates can include calcium nitrate. Further, the reactant solution can include a metal chelate including a metal or oxometal ion including titanium and at least one of zirconium, yttrium, manganese, neodymium, tin, zinc, vanadium, niobium, tantalum, molybdenum, tungsten, lanthanum, hafnium, chromium, or any combination thereof. In an example, the metal chelate is a stabilized metal chelate including an alpha-hydroxycarboxylic acid, such as citric acid, stabilized with ammonium hydroxide or tetraalkylammonium hydroxide.

A second reactant solution can include tetraalkylammonium hydroxide, tetraalkylammonium oxalate, or a combination thereof. In a particular example, the second reactive solution includes a mixture of tetraalkylammonium hydroxide and tetraalkylammonium oxalate. The alkyl group of the tetraalkylammonium hydroxide or tetraalkylammonium oxalate can be a methyl, ethyl, or propyl group, or any combination thereof.

The reactant solutions are injected into the tubular reactor to provide both a desirable turbulence factor and other reaction conditions. In particular, the turbulence factor is at least 1.5×10⁷ cm/s³. The pH of the reaction can be in a range of 8 to 12, such as a range of 10 to 12. The temperature of the reactor can be in a range of 75° C. to 120° C., such as a range of 80° C. to 110° C., a range of 90° C. to 105° C., or even a range of 90° C. to 100° C. The pressure of the streams can be in the range of 90 psi to 120 psi or higher depending on the application. The residence time within the reactor can be at least 50 milliseconds.

In the tubular reactor, barium nitrate, titanium chelate, and other nitrate and chelate constituents coprecipitate to form a compositionally homogeneous particulate. Each particle within the compositionally homogeneous particulate has approximately the same composition, in contrast to a mixture of particles of different composition.

In one embodiment, the two ingredient streams, one containing the aqueous solution of all the metal-ion compound precursors and the other containing the aqueous solution of the ammonium oxalate or tetramethylammonium oxalate and tetramethylammonium hydroxide are reacted together simultaneously and continuously in a fluid jet column that provides a high turbulence energy environment. The ingredient streams can be heated, for example, to 95° C. to 99° C. The total volume for the saturated or near-saturated commercially available and specially manufactured aqueous solutions of the precursors is typically larger than that of the ammonium oxalate or tetramethylammonium oxalate and tetramethylammonium hydroxide in aqueous solution. There are generally two options in this case for the jet fluid column: (1) adjust the former to a flow rate proportionally larger than that of the latter, keeping the stream velocities equal by having the applied driving pressure to the two streams the same, but with the cross-sectional area of the nozzle of the former proportionally larger than that of the latter; and (2) dilute one volume of the latter by a proportional volume of DI water, thereby lowering the concentration of the precipitant. With equal volumes for both streams, the nozzles are alike, the flow rates are equal, and the applied driving pressure is the same. The amount of liquid processed is generally greater than that of the first option, however. The first option has the substantial advantage of reducing the amount of liquid handling and the usage of DI water.

In other embodiments, other techniques and devices can be used to combine the ingredient streams such as, for example: (1) pouring one solution in one vessel into the other solution in another vessel and using mechanical or ultrasonic mixing, and (2) metering the solution in one vessel at some given flow rate into the other solution in another vessel and using mechanical or ultrasonic mixing.

Returning to FIG. 2, in the hydrothermal treatment chamber 210, the reactor product streams are treated at a temperature of at least 150° C. and a pressure of least 100 psi (or at a pressure that limits boiling) for a period of at least 4 hours. For example, the temperature can be at least 175° C., such as at least 190° C. if the associated pressure is also increased. Further, the pressure can be at least 225 psi, such as at least 245 psi, or even at least 250 psi or higher. The hydrothermal treatment is performed for a period of at least 4 hours, such as at least 5 hours, or even at least 6 hours. In an example, the hydrothermal treatment is performed at a temperature in a range of 150° C. to 200° C. and a pressure in a range of 225 psi to 260 psi for a period in a range of 4 hours to 8 hours. Higher temperature and pressure combinations can be utilized if desired. In a particular example, the top of the hydrothermal treatment vessel can be cooled to facilitate reflux.

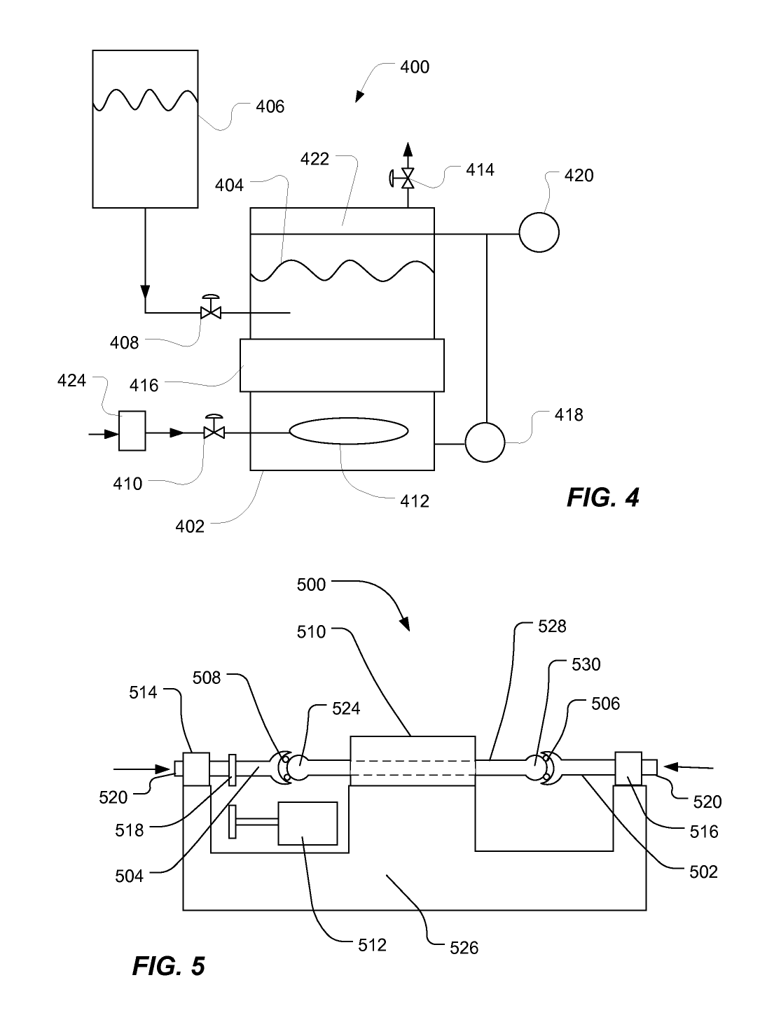

In an exemplary embodiment of the hydrothermal treatment chamber 210 illustrated in FIG. 2, the hydrothermal treatment system 400 of FIG. 4 includes a pressure vessel 402. For example, the pressure vessel 402 can be configured for pressure of at least 250 psi, such as at least 350 psi, at least 400 psi, or even at least 500 psi or higher. The pressure rating can be as high as 1500 psi or higher. The hydrothermal treatment system 400 also includes a heat source 416. For example, the heat source 416 can be heat tape wrapped around the outside of the pressure vessel 402. In another example, the heat source 416 can be in contact with the bottom of the pressure vessel 402. Alternatively, the heat source 416 can be disposed on the bottom and side of the pressure vessel 402. In a further example, the top of the pressure vessel 402 can be cooled to facilitate reflux. For example, the top of the pressure vessel 402 can include a water or air cooling system 422 or can be free of insulation, resulting in cooling near the top.

In addition, the hydrothermal treatment system can include a source of cool water, such as a vessel 406, coupled via a fluid control system to the pressure vessel 402. For example, the vessel 406 can include water or an aqueous solution including tetraalkylammonium hydroxide. The water or aqueous solution can be at a temperature not greater than 100° C., such as not greater than 50° C. or even approximately room temperature (approximately 20° C. to 25° C.). In an example, the vessel 406 is pressurized to a pressure greater than the pressure of the pressure vessel 402 during hydrothermal treatment and the fluid control system can include a control valve 408. During hydrothermal treatment, the control valve 408 can release fluid from the vessel 406, which is pressurized to a pressure that allows a flow of liquid from the vessel 406 into the pressure vessel 402, at a location below the level of the fluid surface 404. Alternatively, the fluid control system can include a pump. The fluid can be provided to the system above the fluid surface 404 or alternatively, can be provided below the fluid surface 404. In particular, the solution can provide a desirable pH and can be used to facilitate thermally-induced mixing and control pH during hydrothermal treatment.

Further, the hydrothermal treatment system 400 can include a source of compressed gas, such as compressed air. As illustrated in FIG. 4, the pressure vessels 402 includes a control valve 410 in communication with a source of compressed gas or high pressure clean dry air and a manifold 412 to distribute the compressed gas. For example, the control valve 410 can introduce compressed air into the pressure vessel 402. The manifold 412 can distribute the air to facilitate mixing in the pressure vessel 402. In particular, the compressed gas or air is provided below the fluid surface 404. The air can be heated or can be at room temperature (approximately to 20° C. to 25° C.). A pressure regulator 424 can control the inlet air pressure to pressure vessel 402 to ensure adequate air flow into the pressure vessel 402 for the application. Such action provides mixing of the aqueous solution in the pressure vessel 402, for example, without mechanical mixing.

With the addition of heat, an aqueous solution, or compressed gas, pressure within the pressure vessel 402 can increase. Pressure can be measured using pressure gauge 420. In addition, the level of fluid within the pressure vessel 402 can be measured, for example, using a differential pressure gauge 418. Alternatively, fluid level can be measured using two separate pressure gauges. To assist the bubbling air mixing process, a control valve 414 coupled to the pressure vessel 402 can release gas, such as air, from the pressure vessel, maintaining a desired pressure and air flow within and from the pressure vessel 402. The continuous addition of compressed gas during the hydrothermal treatment provides an open system.

In co-precipitation procedures from aqueous solution where a strong base hydroxide is used as the precipitant, gelatinous amorphous hydrous hydroxides result. Such precipitates can be difficult to filter, e.g., clogging filter cartridges, but also require a lengthy reflux time in the mother liquid, typically at 93° C. at atmospheric pressure for 8 to 36 hours, to densify and transform to the crystalline or near crystalline state, which is desirable to facilitate easy filtration and to obtain a useful product. Although the reflux time can be significantly shortened by use of a high-pressure vessel with steam pressure in the range of 100 atmospheres at 300° C., the vessel, associated valves, actuators, heater, and sensors are complicated and costly.

Such issues pertaining to the use of a strong base hydroxide as the sole precipitant can be circumvented by the choice of an aqueous solution of ammonium oxalate or tetramethylammonium oxalate and tetramethylammonium hydroxide, to form at the reaction of the precursor and precipitant solutions a pH in the range of 8.0 to 12.0, such as a range of 9.0 to 11.0, as the precipitant. As a precipitant, ammonium oxalate or tetramethylammonium oxalate has the same advantage as tetraalkylammonium hydroxide in being thermally decomposed and oxidized away by conversion to gaseous products during the decomposition and calcination-in-air step of the product powder. However, unlike hydrous hydroxide precipitates, hydrated hydroxide-oxalate precipitates are partial crystalline when formed in aqueous solution, are more easily filtered, are easily and quickly dried in an oven and are more easily converted to the desired oxide (or mixed oxide) end product by calcination in air in a silica glass (fused quartz) tube furnace from ambient to approximately 1100° C. or higher.

The resulting slurry, following hydrothermal treatment, is transferred from the mixing vessel or hydrothermal tank to a filtration or separation device. Separating the precipitate from the liquid phase and isolating precipitate can be carried out using a variety of devices and techniques including conventional filtering, vacuum filtering, centrifugal separation, sedimentation, spray drying, freeze drying, or the like. The filtered powder can then undergo various washing, drying, and decomposition and calcining steps as desired.

Returning to FIG. 2, following hydrothermal treatment, the resulting particulate material can be dried in a dryer 218. For example, the dielectric particulate material can be dried in a spray dryer, a pan dryer, a flash dryer, a cryogenic dryer, or any combination thereof. In a particular example, the dielectric particulate material is dried in a flash dryer. Prior to drying, the particulate material can be washed and partially separated. For example, the particulate material can be washed using deionized water and can be concentrated using a centrifuge. The washing and concentrating can be repeated one or more times.

Washing of the precipitated powder is optional because residual precipitant, the ammonium oxalate or tetramethylammonium oxalate and tetramethylammonium hydroxide residuals, and other residuals, can be volatilized during drying or heat treatment. In some embodiments, deionized (DI) water washing step, or some other washing step, is performed.

Once dried, the particulate material can undergo decomposition and calcining in a furnace 220 as indicated in FIG. 2. For example, the particulate material can be heated at a temperature in a range of 25° C. to 1100° C. or higher. In particular, the material can be heated in an oxygenated and agitated environment to facilitate decomposition of organic byproducts and formation of a desired particulate material. Thus, by the nonmetal-ion-containing ammonium oxalate or tetramethylammonium oxalate and tetramethylammonium hydroxide an aqueous solution of water-soluble hydrated and chelated metal-ion species in their proportioned amounts is precipitated as a hydrated oxalate-hydroxide and by decomposition and calcination in air converted to the oxide (the composition-modified barium titanate).

In wet-chemical methods for the preparation of ceramic powders by co-precipitation of a mixture of precursors from solution, small amounts of precipitant and water typically are included within the micropores and nanopores of the product powder. Similarly, small amounts of precipitant and water can also be adsorbed onto the surface of product powder. During calcination in air of the product powder, half of the oxygen of the oxalate anion in its thermal decomposition becomes part of a mixed oxide compound and the other half with the carbon is converted by oxidation to carbon dioxide gas, and solution residuals such as ammonium oxalate [(NH₄)₂C₂O₄] (any excess amount) or tetramethylammonium oxalate {[(CH₃)₄N]₂C₂O₄} (any excess amount), tetramethylammonium hydroxide [(CH₃)₄NOH] (any excess amount), ammonium nitrate (NH₄NO₃), ammonium 2-hydroxypropanate[CH₃CH(OH)COONH₄)], and triammonium 2-hydroxy-1,2,3-propanetricarboxylate [(OH)C(COONH₄)(CH₂COONH₄)₂]. These residuals are thermally decomposed and oxidized and thereby completely converted to gaseous products such as H₂O, NH₃, CO, CO₂, N₂, N₂O, NO, and NO₂. The decomposition of these residuals occurs over specified temperature ranges, rates of temperature increase, with acceptable clean dry air flow to assist in sweeping the gaseous products away at an acceptable rate. The decomposition generally applies to 2-hydroxycarboxylic acid or alpha-hydroxycarboxylic acids selected as a chelating agent, as described below.

In a particular example, the furnace 220 illustrated in FIG. 2 is a horizontal tube furnace. An exemplary furnace assembly 500 is illustrated in FIG. 5. A tube assembly 528 is held into a horizontal furnace 510 by two coupler joints 502 and 504, one at each end of the tube assembly 528. In particular, the tube assembly 528 can be formed of fused quartz. For example, the two coupler joints 502 and 504 can be formed of stainless steel. The two coupler joints 502 and 504 can be attached to a frame 526 of the furnace 510 and aligned so as to have the tube assembly 528 aligned through the center of the furnace 510 when connected to the connector portions 522 and 520 at each end of the tube assembly 528. The coupler joints 502 and 504 can include o-rings 506 and 508 to assist in sealing the coupler joints 502 and 504 to the connector portions 522 and 520. In particular, the o-rings 506 and 508 can assist in sealing two different materials to each other, e.g., metal to quartz. In addition, clamps can be used to rigidly hold the connector portions 522 and 520 and the coupler joints 502 and 504 together during operation of the furnace 510. For example, the ball-joints 524 and 530 can be clamped to metal coupler joints 504 and 502 at ball-couplers, respectively. In a particular example, the coupler joints 502 and 504 are hollow tubes connected to hollow ball-couplers. At each end of the tubes that are connected to the metal ball-couplers can be ferrofluidic bearing seals 514 and 516 that are attached to the tube furnace frame 526 and that can ensure alignment of the assembly 528 and ball-coupler assemblies 502 and 504 to the furnace 510.

In operation, clean dry air flows through the coupler-joints 502 and 504 and the tube assembly 528. For example, the clean dry air can flow at a rate of at least 10 standard cubic feet per hour (SCFH), such as at least 15 SCFH. In another example, the clean dry air can flow at a rate of not greater than 50 SCFH, such as not greater than 40 SCFH, or even not greater than 30 SCFH. The flow rate of clean dry air, expressed as a ratio relative to the internal volume of the fused quartz assembly is at least 1000 h⁻¹, such as at least 1400 h⁻¹, at least 1600 h⁻¹, at least 1800 h⁻¹, at least 2000 h⁻¹, at least 2200 h⁻¹, or even at least 2400 h⁻¹. The flow rate ratio may be not greater than 8100 h⁻¹, such as not greater than 6500 h⁻¹, or even not greater than 4900 h⁻¹. In a particular example, the direction of flow of the clean dry air is alternated, for example, changing direction after at least 5 seconds, such as after at least 10 seconds. The clean dry air can change directions after a period not greater than 60 seconds, such as not greater than 50 seconds, or even not greater than 40 seconds.

A gear/motor drive assembly 512 and 518 is attached to the coupler-joint 504 and rotates the tube assembly 528 at a specified rate during processing. In an example, the tube assembly 528 is rotated at a rate of at least 1 revolution per minute, such as at least 20 revolutions per minute or even at least 40 revolutions per minute. The tube assembly 528 can be rotated at a rate of not greater than 120 revolutions per minute, such as not greater than 100 revolutions per minute, not greater than 80 revolutions per minute, or even not greater than 70 revolutions per minute. In a particular example, the tube assembly 528 is rotated at a rate between 40 revolutions per minute and 70 revolutions per minute, such as between 50 revolutions per minute and 70 revolutions per minute.

A controller can provide for control of the processing parameters for the tube furnace assembly after powders have been placed into the tube assembly 528 and the tube assembly 528 has been installed into the furnace 510. For example, the quartz tube assembly is rotated at the specified rate, clean dry air flow is set to the specified rate, clean dry air (CDA) Flow Duration in alternating directions through the quartz assembly is set, and temperature profile is run at the specified temperature setting and key temperature durations.

During the alternating CDA flow, e.g., 15 to 30 SCFH, durations the tube furnace temperature is ramped up in a manner that allows for successful decomposition and calcining followed by an acceptable ramp down to room temperature. Different powder compositions can utilize different temperature ramp up and ramp down profiles which can be controlled by changing settings of the tube furnace temperature controller.

In an example, calcining can be performed at a temperature in the range of 1000° C. to 1125° C. A exemplary temperature ramp cycle for composition-modified barium titanate powders has a sequence as follows:

Remove water from powder, e.g., ramp from 25° C. to 200° C. in 30 minutes;

Initiate CO₂ evolution, e.g., ramp from 200° C. to 600° C. in 180 minutes;

Control CO₂ evolution, e.g., ramp from 600° C. to 850° C. in 120 minutes (can be controlled, for example, with FTIR analysis of evolving gas);

Initiate calcining, e.g., ramp from 850° C. to 1125° C. in 60 minutes;

Calcine, e.g., dwell at approximately 1125° C. for 180 minutes;

Cool down, e.g., ramp from 1125° C. to 300° C. in 60 minutes;

Introduce O₂, e.g., dwell at 300° C. for 120 minutes; and

Further cool down, e.g., ramp from 300° C. to 25° C. in 60 minutes.

In particular, poor decomposition and calcinations conditions result in dielectric ceramic particulate having poor properties. Decomposition and calcining as described above can help to limit fracturing and faults within the particles, leading to improved properties, such as permittivity.

The resulting dielectric ceramic particles have desirable properties. As a result of the process, a desirable dielectric particulate is provided. In particular, the dielectric particulate has a desirable particle size and particle size distribution. For example, the average (mean) particle size is at least 0.6 μm, excluding particles of size less than 0.1 micrometers or greater than 10 micrometers, such as at least 0.7 μm. In an example, the average particle size is in a range of 0.6 to 2 μm, such as a range of 0.7 to 1.5 μm, a range of 0.9 to 1.5 μm, a range of 0.9 to 1.4 μm, or a range of 1.2 to 1.5 μm. Alternatively, the average particle size can be in a range of 0.6 to 1 μm, such as 0.6 to 0.9 μm, or even a range of 0.7 to 0.9 μm.

In any case, the particle size distribution exhibits a half height ratio of not greater than 0.5. The half height ratio is defined as the ratio of the width of the particle size distribution at half of its maximum height and the average (mean) particle size for the distribution peak centered on the mean size. For example, the half height ratio may be not greater than 0.45, such as not greater than 0.4, not greater than 0.3, or even not greater than 0.2. Further, the standard deviation may be not greater than 2.0 micrometers, such as not greater than 1.5 micrometers, not greater than 1.3 micrometers, not greater than 1.2 micrometers, or even not greater than 1.15 micrometers.

In a particular embodiment, the dielectric ceramic particulate includes a cubic perovskite composition-modified barium titanate powder. The barium is at least partially substituted with calcium, neodymium, lanthanum, or a combination thereof, and the titanium is at least partially substituted with at least one of zirconium, yttrium, manganese, neodymium, tin, zinc, vanadium, niobium, tantalum, molybdenum, tungsten, hafnium, chromium, or any combination thereof. The composition-modified barium titanate powder has an average particular size in a range of 0.6 to 1.5 micrometers, and a half width ratio of not greater than 0.5.

In addition, the dielectric ceramic particulate can have a domain size in a range of 100 Å to 600 Å, such as a range of 150 Å to 550 Å, a range of 200 Å to 550 Å, or even a range of 250 Å to 500 Å.

In particular, the ceramic powder is paraelectric in a temperature range, such as temperature range of −40° C. to +85° C. or a temperature range of −25° C. to +55° C. Further, the ceramic powder is free of or has low concentrations of strontium or iron ions. In particular, the ceramic powder has a high-permittivity within the above temperature ranges, such as a relative permittivity (K) of at least 15000, such as at least 18000. In an example, the dielectric particulate exhibits a desirable relative permittivity, such as at least 15,000, at least 17,500, at least 18,000, or even at least 20,000. In an example, the relative permittivity can be at least 30,000, such as at least 35,000, at least 50,000, at least 65,000, or even at least 80,000 or higher.

### Coating Dielectric Ceramic Particulate

Returning to FIG. 1, as illustrated at 106, the dielectric ceramic powder can be optionally coated. For example, the powder can be coated with a ceramic coating or a polymeric coating. In a particular example, the powder is coated with a ceramic coating, such as a metal oxide, for example, an aluminum oxide coating. An exemplary polymer coating can include polyester, such as polyethylene terephthalate, polyethylene naphthalate, or any combination thereof. The coating may act to limit oxygen ion transport across the boundaries of the ceramic particulate and may limit contact between adjacent particles that would result in a reduced relative permittivity. If the composition-modified barium titanate (CMBT) powders are mixed into a polymer matrix then the coating of the CMBT powder may be a thin layer of aluminum oxide or other coatings to increase the dielectric strength and an outer layer wetting of a surface agent, such as an amphiphilic agent, to assist in dispersing the powders into the polymer matrix material. Amphiphilic agents such as, but not limited to, amino propyl triethoxysilane, vinyl benzyl amino ethyl amino propyl trimethoxysilane, methacryloxypropyl trimehtoxysilane, glycidoxypropyl trimethoxysilane, phenyl trimethoxysilane, or any combination thereof, are chosen such that the organic group is compatible with the polymer into which the CMBT powder is being dispersed. Alternatively, the trialkoxysilane functional group can be substituted with a phosphonic, sulfonic, or carbonic acid group.

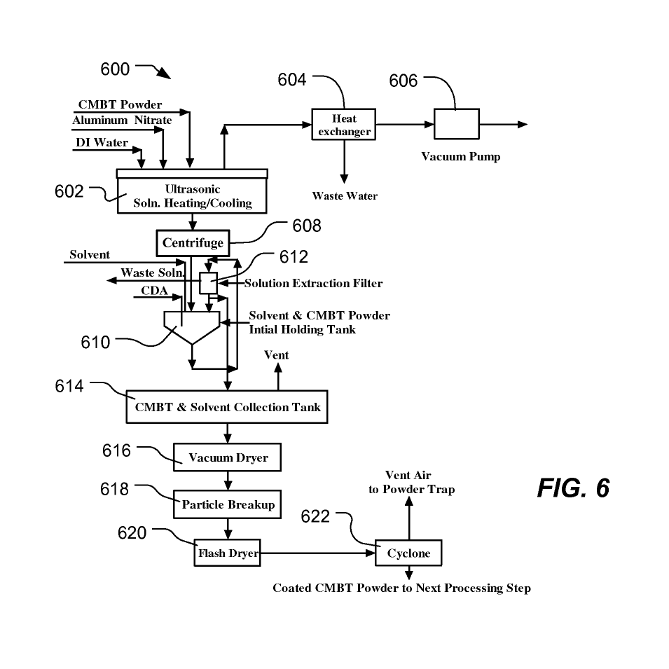

In particular, the coating includes a metal oxide, such as aluminum nitrate. As illustrated in FIG. 6, a system 600 includes a mixing vessel 602. The mixing vessel 602 can be temperature controlled and can include ultrasonic mechanisms. In an example, the ceramic powder, such as a CMBT powder can be added to an aqueous solution including deionized (DI) water and a metal nitrate, such as aluminum nitrate. The solution can be adjusted to achieve metal nitrate saturation or supersaturation, which results in deposition of the metal nitrate on the ceramic powder. In an example, the solution can be heated, placed under vacuum, or a combination thereof to remove water through evaporation, resulting in a saturated metal nitrate solution. For example, the system 600 can include a vacuum pump 606 and a heat exchanger 604 to remove evaporated water before it reaches the vacuum pump 606. In another example, the solution can be saturated by reducing the temperature, changing the solubility of the metal nitrate in the solution. In a further example, the solution can be saturated by first removing water followed by cooling to produce a saturated or supersaturated metal nitrate solution.

Once the metal nitrate coating is applied, the coated dielectric ceramic particulate can be separated from the remaining aqueous solution. For example, the coated ceramic particulate can be separated using a centrifuge 608. The separated ceramic particulate can be transferred to a washing vessel 610. The ceramic particulate can be washed using a solvent that exhibits low solubility for the metal nitrate. For example, the solvent can be a low molecular weight alcohol, such as ethanol. The solvent can be regenerated, removing water, such as in extraction filter 612.

Once washed, the coated ceramic particulate can be forwarded to a collection tank 614. The coated ceramic particulate can be dried, for example, in a vacuum drier 616, disagglomerated, for example, crushed or milled at a particle breakup unit 618, and heat treated to form a metal oxide from the metal nitrate, such as through a flash dryer 620. To recapture the metal oxide coated ceramic particulate, a cyclone 622 can be used.

An exemplary method includes providing a ceramic powder, such as CMBT powder to a vessel including an aqueous solution of metal nitrate, such as aluminum nitrate. In an example, the temperature of the solution is increased to at least within 5° C. of the normal boiling point of the solution, such as to at least the boiling point of the solution or approximately 100° C. to remove water through evaporation. A vacuum can also be applied to increase the evaporation rate of water. Water is evaporated to increase the concentration of the metal nitrate. For example, the concentration can be increased to near saturation, saturation, or supersaturation.

In addition or alternatively, the solution can be cooled to achieve saturation. Cooling can be performed following evaporation through heating or pressure reduction. In an example, cooling includes cooling by at least 25° C., such as at least 40° C., at least 60° C., or even at least 70° C. Cooling may include cooling to a temperature not greater than 35° C., such as not greater than 30° C., or even not greater than 28° C.

As a result of approaching saturation, metal nitrate is coated over the ceramic particulate. In an example, the metal nitrate is aluminum nitrate, such as aluminum nitrate nona-hydrate. The coated ceramic particulate can be separated from solution, such as using a filtering, centrifuging or a combination thereof. For example, the coated particles can be separated with a centrifuge, such as a cyclone centrifuge and can be transferred to a wash vessel. When saturation is achieved through evaporation and not cooling, the separation equipment can be heated. For example, the separation equipment can be heated to a temperature within at least 20° C. of the evaporation temperature, such as within at least 15° C., or even within at least 10° C. When deposition is achieved through cooling, particularly cooling to a temperature near room temperature, the separation equipment may be not heated, such as maintained near room temperature.

The wash vessel is to dewater or remove water from the coated particles. For example, a non-aqueous solvent, such as an alcohol, a ketone, or a glycol, can be added to the wash vessel and the solution bubbled to remove water. In an example, the non-aqueous solvent includes an alcohol that has a normal boiling point not greater than the normal boiling point of water. For example, the alcohol can be ethanol. In particular, the non-aqueous solvent has a solubility ratio, defined as the ratio of solubility of the metal nitrate in water relative to the solubility of the metal nitrate in the non-aqueous solvent at a given temperature (e.g., the temperature of the solvent extraction), of at least 2, such as at least 3, or even at least 4.

The solvent can be cycled until sufficient water is removed. In particular, dewatering, such as through solvent extraction, can be performed at a temperature not greater than 50° C., such as not greater than 35° C., or even not greater than 30° C.

The solvent and coated powder can be transferred to a collection tank, such as through pumping. A spray dryer can be used to remove the solvent and the coated powder can be further vacuum dried to remove the solvent.

Following drying, the coated particles can be further processed to prevent agglomeration. For example, the coated particles can be mechanically treated to break agglomerates, such as through milling or crushing.

To form an oxide coating from the metal nitrate coating, the coated ceramic powder can be further heat treated. In an example, the coated ceramic powder is heated to a temperature of at least 200° C., such as a temperature of at least 225° C., at least 250° C., or even at least 275° C. For example, the coated ceramic powder can be flash dried. A centrifuge can be used to collect the oxide coated powders.

The collected oxide coated composition-modified barium titanate ceramic powders can be transferred for further processing. In an example, the coated particles can be further processed to prevent agglomeration, such as through mechanically treatment to break agglomerates, for example, milling or crushing. In another example, coated ceramic powders can be used in an ink, coating, or polymer composite to form electronic components, such as dielectric components, for example, capacitive energy storage devices or capacitors.

In a particular example, the coated ceramic particles can have an average particle size (e.g., diameter or width) in a range of 0.5 micrometer to 5 micrometers, such as a range of 0.5 micrometers to 2 micrometers, or even a range of 0.7 micrometers to 1.5 micrometers. The oxide coating on the coated ceramic particles can have an average thickness in a range of 50 Å to 500 Å, such as a range of 50 Å to 200 Å, or even a range of 50 Å to 150 Å.

Upscaling is proportional to the amount of ceramic powder in the process. The relative permittivity of aluminum oxide is approximately 8.2 over the temperature range of −20° C. to +60° C. and a frequency range of 1 kHz to over 100 MHz. This low relative permittivity aluminum oxide layer of 100 Åcan reduce the overall relative permittivity of the dielectric layer by approximately 6%. Checking the relativity permittivity of the CMBT powders before coating and after coating provides an excellent quality control check on coating thickness.

Washing the powders with ethanol after coating removes the water from the powders to a level that when dried reduces the hard agglomeration of the powders. Drying the powders in a solvent solution of ethanol assists in allowing the powders to be readily broken up into fine particles for the final anti-agglomeration process of the flash drying unit.

Some aluminum nitrate is removed due to washing the coated powder in the ethanol solution. Additional aluminum nitrate coating thickness can be added to allow some nitrate removal during washing so that the final thickness is close to the 100 Åcoating thickness. However, if less removal of the aluminum nitrate coating is desired during the water removal step, the ethanol can be cooled to lower the solubility of the nitrate compound in the cooled ethanol.

Preparation of the high-permittivity calcined composition-modified barium titanate powder in this manner yields high-purity powders with narrow particle-size distribution. The microstructures of ceramics formed from these calcined wet-chemical-prepared powders are uniform in grain size and can also result in smaller grain size. Electrical properties are improved so that increased dielectric breakdown strengths can be obtained. Further improvement can include longer device life.

To coat the powders with a dispersant, such as an amphiphilic agent, the powder can be mixed with the dispersant and a solvent. The solvent can be removed through evaporation or drying processes as described above, providing the optional dispersant coating. In addition or alternatively, small quantities of solvent, such as an aromatic solvent, can be coated on the surface of the particles. An exemplary aromatic solvent includes benzene, xylene, toluene, phenol, or any combination thereof.

### Prepare Device

The specifically prepared dielectric ceramic particulate can be incorporated into a capacitive electrical energy storage device, as illustrated at 108 of FIG. 1. In particular, the dielectric ceramic particulate can be incorporated into a matrix that is used to form dielectric layers between electrodes within capacitive elements. Capacitive elements can be stacked or connected together to form capacitive components and the capacitive components can be assembled into electric storage devices. The electric storage devices including the interconnected capacitive components can have an energy storage density of at least 0.45 kW·h/kg and a breakdown voltage of at least 1100 V, such as at least 5000V.

By preparing the energy storage devices using high relative permittivity dielectric ceramic particulate, and using layering techniques as also described below, high capacity electrical energy storage devices can be formed that are both energy efficient and commercially viable.

In an example, the dielectric ceramic particulate can be mixed with a matrix material to form a dielectric composite. The matrix material forms a continuous phase within which the dielectric ceramic particulate is dispersed. An exemplary matrix material includes a vitreous glass. In another example, the matrix material includes a polymeric material. An exemplary polymeric material can include a polarizable polymer. An exemplary polymer includes a polyester, such as polyethylene terephthalate (PET) or polyethylene naphthalate (PEN). Alternatively, another polymer can be substituted for PET. For example, other polyesters can be used. In particular, a polymeric material having sufficient voltage breakdown and being polarizable can be used.

Other polymers include polyethylene, such as polyethylene (PE), low density polyethylene (LDPE), high density polyethylene (HDPE), linear low density polyethylene (LLDPE), crosslinked polyethylene (XLPE), or ultra high molecular weight polyethylene (UHMWPE); other polyolefins, such as polypropylene (PP), biaxially-oriented polypropylene, polybutylene (PB), or polyisobutene (PIB); polyacrylates, such as polymethyl methacrylate (PMMA), polymethyl acrylate (PMA), hydroxyethyl methacrylate (HEMA), or sodium polyacrylate; polystyrene, such as polystyrene (PS), high impact polystyrene (HIPS), extruded polystyrene (XPS), or expanded polystyrene; polyester, such as PET or PEN; liquid crystal polymers, such as an aromatic polyester or a polyesteramide, including polymers available under tradenames XYDAR® (Amoco), VECTRA® (Hoechst Celanese), SUMIKOSUPER™ or EKONOL™ (Sumitomo Chemical), DuPont HX™ or DuPont ZENITE™ (E.I. DuPont de Nemours), RODRUN™ (Unitika), GRANLAR™ (Grandmont), or any combination thereof; polysulfone, such as polysulfone (PSU), polyarylsulfone (PAS), polyethersulfone (PES), or polyphenylsulfone (PPS); polyamide, such as polyamide (PA), polyphthalamide (PPA), bismaleimide (BMI), or urea formaldehyde (UF); polyimide; cyanate based polymers, such as polyurethane (PU), or polyisocyanurate (PIR); chloropolymer, such as polyvinyl chloride (PVC), or polyvinylidene dichloride (PVDC); (chloro)fluoropolymer, such as polychlorotrifluoroethlyene (PCTFE) or ethylene chlorotrifluoroethlyene (ECTFE); fluoropolymer, such as polytetrafluoroethylene (PTFE), or polyvinylidene difluoride (PVDF); other homopolymer, such as polycarbonate (PC), polylactic acid (PLA), polyacrylamide (PAM), polybenzimidazole, or polyetheretherketone (PEEK); other copolymer, such as acrylonitrile butadiene styrene (ABS), or polybutadiene acrylonitrile (PBAN); or any combination thereof.

In an example, the polymer is not conductive. For example, the polymer is not conductive for electrons, protons, or ions. In a particular example, the polymer is a purified polymer, for which the monomers were ion exchanged or otherwise cleaned of conductive ions prior to polymerization or for which the polymer has been cleaned of conductive ions, such as through ion exchange. In an example, the polymer is a purified polyethylene terephthalate. The polymer, such as the polyethylene terephthalate, can have a breakdown voltage of at least 350 V/μm, such as at least 500 V/μm, or even at least 700 V/μm.

The dielectric composite is applied in layers in conjunction with conductive layers to form capacitive elements that are stacked to provide a component. Components are electrically connected to form an energy storage device. Electrical energy can be stored within the capacitive elements by applying voltage across the poles of the energy storage device. The layers of the capacitive elements can be formed by printing or coating. For example, the layers can be screen printed, drop printed, or continuously printed. Drop printing applies material as an ink arranged in successive drops. Continuous printing applies material as an ink in a continuous stream, forming a line having thickness and depth in part determined by the rate and movement of a print head.

In an example, portions of the layers of the capacitive elements are formed through deposition of inks. An ink can include a solvent and conductive particulate. Another ink can include a solvent and a polymeric material. A further ink can include a solvent, a matrix material, and the dielectric ceramic particulate. The inks can be formed through high shear mixing.

Each of the inks includes a solvent and optionally a binder. In an exemplary embodiment, the solvent can be a polar organic solvent, including, for example, an alcohol such as propyl alcohol or isopropyl alcohol; a ketone such as methyl ethyl ketone or acetone; a glycol such as ethylene glycol, 1,2-propylene glycol, 1,3-propylene glycol, or diethylene glycol; a glycol ether such as diethylene glycol monoether, ethylene glycol butyl ether, diethylene glycol monobutyl ether, dipropylene glycol monomethyl ether, or ethylene glycol monoethyl ether; glycerol (glycerine or 1,2,3-propanetriol); an ester; an aldehyde; or any combination thereof. Alternatively, the solvent can be a nonpolar organic solvent including, for example, aliphatic hydrocarbons, such as hexane or mixed alkanes, or aromatic hydrocarbons, such as benzene or toluene. In another example, the solvent can dissolve a polymer, such as hexafluoroisopropanol (HFIP) or phenol for PET, pyridine for PC, N, and N-dimethylformamide for PVDF.

In a further exemplary embodiment, the ink can include more than one solvent. For example, the ink can include a first solvent and a second solvent. The first solvent can be a solvent having a boiling point in a first range of temperatures, and the second solvent can be a solvent having a boiling point in a second range of temperatures, such as a range of temperatures higher than the first range of temperatures. As a result, the rate of evaporation of the first solvent can be higher than the rate of evaporation of the second solvent at a given temperature. Accordingly, the viscosity of the ink can change as the first solvent is evaporated, while providing a desirable rheology. In particular, the difference between the evaporation temperature of the first solvent and that of the second solvent can be at least about 10° C., such as at least about 25° C., at least about 50° C., or even at least about 75° C. In a particular embodiment, the first solvent can have a boiling point of not greater than about 140° C., and the second solvent can have a boiling point of at least about 170° C.

In an example, a binder can be configured to burn-out after deposition. An exemplary binder includes a cellulose-based binder. An example of a cellulose-based binder includes methyl cellulose ether, ethylpropyl cellulose ether, hydroxypropyl cellulose ether, cellulose acetate butyrate, nitrocellulose, or any combination thereof.

In an example, the polymeric material has a particle size of not greater than 10 microns. For example, the particle size of the polymer may be not greater than 5 microns, such as not greater than 2 microns, not greater than 1 micron, or even not greater than 0.5 microns. In particular, the particle size is not greater than 3 microns, such as not greater than 2 microns. In an example, the particle size can be greater than 0.01 microns.

In addition, the inks forming a polymer layer and those forming a dielectric layer can include a polarizable polymer. An exemplary polymer includes a polyester, such as PET or PEN. Alternatively, another polymer can be substituted for PET in each of the proposed inks including PET. For example, other polyesters can be used. In particular, a polymeric material having sufficient voltage breakdown and being polarizable can be used.

Other polymers include polyethylene, such as PE, LDPE, HDPE, LLDPE, XLPE, or UHMWPE; other polyolefins, such as PP, PB, or PIB; polyacrylates, such as PMMA, PMA, HEMA, or sodium polyacrylate; polystyrene, such as PS, HIPS, XPS, or expanded polystyrene; polyester, such as PET or PEN; liquid crystal polymers, such as an aromatic polyester or a polyesteramide, including polymers available under tradenames XYDAR® (Amoco), VECTRA® (Hoechst Celanese), SUMIKOSUPER™ or EKONOL™ (Sumitomo Chemical), DuPont HX™ or DuPont ZENITE™ (E.I. DuPont de Nemours), RODRUN™ (Unitika), GRANLAR™ (Grandmont), or any combination thereof; polysulfone, such as PSU, PAS, PES, or PPS; polyamide, such as PA, PPA, BMI, or UF; polyimide; cyanate based polymers, such as PU, or PIR; chloropolymer, such as PVC, or PVDC; (chloro)fluoropolymer, such as PCTFE or ECTFE; fluoropolymer, such as PTFE, or PVDF; other homopolymer, such as PC, PLA, PAM, polybenzimidazole, or PEEK; other copolymer, such as ABS, or PBAN; or any combination thereof.

Further, inks forming conductive layers for electrodes include conductive materials. An exemplary conductive material includes metals, metal alloys, or conductive particles, such as carbon black or graphite, or any combination thereof. An exemplary metal includes aluminum, copper, zinc, tin, nickel, beryllium, manganese, iron, titanium, or any combination thereof. For example, the metal includes aluminum, copper, zinc, tin, nickel, or a combination thereof.

The conductive powder may have a particle size of not greater than 10 microns, such as not greater than 5 microns, not greater than 2 microns, or even not greater than 1 micron. For example, the particle size of the conductive powder may be not greater than 0.5 microns, such as not greater than 0.3 microns, or even not greater than 0.2 microns. In an example, the conductive powder has a particle size of at least 0.01 microns.

An exemplary ink forming a polymeric layer can include solvent in an amount of 5% to 30% by weight. For example, the solvent can be included in an amount of 5% to 20% by weight or even an amount of 5% to 15% by weight. The ink can further include the polymeric powder in an amount of 40% to 70% by weight, such as an amount of 50% to 70% by weight, or even 60% to 70% by weight. Further, the ink can include a binder. If used, the binder can be used in an amount of 0% to 30% by weight, such as an amount of 10% to 30% by weight, 10% to 20% by weight, or even 10% to 15% by weight. While embodiments of the above ink can include additional components, in another example, embodiments of the above ink consists essentially of the above described components, such as consist of the above described components.

An ink useful in forming dielectric layers can include solvent in the amount of 5% to 30% by weight. For example, the solvent can be included in an amount of 5% to 20% by weight, such as 5% to 15% by weight. The ink can further include a polymeric powder in an amount of 5% to 15% by weight. For example, the polymeric powder can be in an amount of 7% to 15% by weight, or even 10% to 15% by weight. Further, the ink includes a dielectric ceramic particulate in an amount of 60% to 80% by weight. For example, the dielectric ceramic can be used in an amount of 65% to 80% by weight, or even 70% to 80% by weight. If used, the ink can also include a binder in an amount of 0% to 30% by weight, such as 10% to 30% by weight, 10% to 20% by weight, or even 10% to 15% by weight. While embodiments of the above ink can include additional components, in another example, embodiments of the above ink consists essentially of the above described components, such as consist of the above described components. Optionally, the dielectric ceramic particulate can be pretreated with a solvent, such as an aromatic solvent, for example, toluene, prior to incorporation into the ink.

An ink forming a conductive layer can include solvent such as in an amount of 5% to 30% by weight. For example, the solvent can be included in an amount of 5% to 20% by weight, or even 5% to 15% by weight. The ink further includes a conductive powder in an amount of 40% to 80% by weight, such as 50% to 80% by weight, or even 60% to 80% by weight. If used, a binder can be used in an amount of 0% to 30% by weight, such as 5% to 20% by weight, or even 5% to 15% by weight. While embodiments of the above ink can include additional components, in another example, embodiments of the above ink consists essentially of the above described components, such as consist of the above described components

The above three inks can be preheated to assist in the evaporation of the solvent during the layering process. Curing (drying) of the layered ink constituents is completed by hot clean dry air being blown onto the ink during the layering process. If additional layer curing is required an inline furnace can be used to complete the curing process.

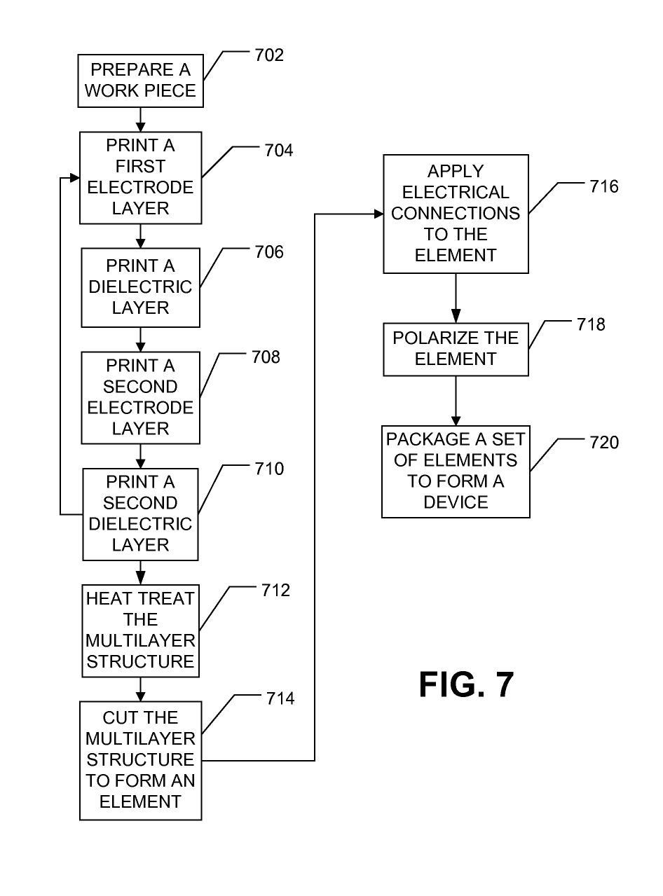

In a particular embodiment, a continuous flow device can be used in conjunction with embodiments of inks and suspensions describe below to form multilayer capacitors. For example, FIG. 7 includes a flow diagram illustrating an exemplary method of forming a capacitive element. As illustrated at 702, a work piece can be prepared and placed on a work piece support. To initiate the formation of the multilayer capacitor, the work piece can include a polymer film or a paper. Alternatively, the work piece support can be coated with polytetrafluoroethylene (PTFE) plastic, and a first layer of a polymer, such as a polyester, can be printed directly upon the work piece support. For example, a layer can be printed with an ink or suspension including solvents or polymeric binders in the amounts described below, absent electrically conductive or dielectric ceramic materials.

As illustrated at 704, a first electrode layer can be printed upon the work piece. The first electrode layer can be an anode layer or a cathode layer. In particular, the first electrode layer can be printed with an ink or suspension including an electrically conductive particulate such as aluminum, copper, nickel, tin or a combination of these electrically conductive particulate. For example, the ink or suspension can include one or more solvents, a burn-out binder, and an electrically conductive particulate. As the ink or suspension is deposited, the composition can form a conductive layer that can act as an electrode. In an example, the first electrode layer can have a thickness of between about 1 μm to about 11 μm. In particular, the ink or suspension is delivered in one or more continuous streams that are concurrently solidified.

Optionally, an insulative layer formed from an ink or suspension including solvents and burn-out organic binder with a dielectric polymeric particulate can be printed to surround the first electrode layer on at least three sides within the plane of the electrode layer. Alternatively, an insulative layer formed from an ink or suspension including solvents and burn-out polymeric binder with a dielectric glass particulate can be printed to surround the first electrode layer within the plane of the electrode layer. In a particular embodiment, the material of the electrode layer can be printed concurrently with at least a portion of the material of the insulative layer. Concurrently is used herein to indicate that events can occur simultaneously, can overlap in time, or one event can begin when another event is ending.

As illustrated at 706, a first dielectric layer can be printed over the first electrode layer. The first dielectric layer can be printed with an ink or suspension including a dielectric particulate. For example, the ink or suspension can include solvents, a burn-out binder (e.g., a cellulose-based binder), and a dielectric particulate material, which when deposited forms a dielectric material layer. The dielectric particulate material can include dielectric ceramic material. In an example, the first dielectric layer can have a thickness of between about 1 μm to about 11 μm. In particular, one or more continuous streams of the dielectric ink can be printed and concurrently solidified to from the dielectric material layer. Optionally, an insulative layer formed from an ink or suspension including solvents and burn-out organic binder, absent particulate filler, but having a dielectric polymeric particulate, can be printed to surround the first dielectric layer on four sides within the plane of the dielectric layer. In an example, the dielectric material layer can be printed concurrently with at least a portion of the insulative layer.

As illustrated at 708, a second electrode layer can be printed upon the first dielectric layer. As with the first electrode layer, the second electrode layer can be printed with an ink or suspension including an electrically conductive particulate. For example, the second electrode layer can be formed from an ink or suspension similar to that used to form the first electrode layer or can be formed from a different ink or suspension. Depending on the first electrode layer, the second electrode layer can be a cathode layer or an anode layer. For example, when the first electrode layer is an anode layer, the second electrode layer can be a cathode layer. The second electrode layer can have a thickness of between about 1 μm to about 11 μm. In a particular embodiment, the second electrode layer can be offset relative to the first electrode layer to permit separate electrical connection, such as separate electrical connection on opposite sides of the capacitive element. Optionally, an insulative layer formed from an ink or suspension including solvents and polymeric binder, absent ceramic filler, but having a dielectric polymeric particulate, can be printed to surround the second electrode layer on at least three sides within the plane of the electrode layer. In an example, the electrode layer can be printed concurrently with at least a portion of the insulative layer.

Further, as illustrated at 710, a second dielectric layer can be printed upon the second electrode layer. The second dielectric layer can be printed with an ink or suspension including a dielectric particulate. The second dielectric layer can be formed from an ink or suspension similar to that used to form the first dielectric layer or can be formed from a different ink or suspension. In an example the second dielectric layer can have a thickness of between about 1 μm to about 11 μm. Optionally, an insulative layer formed from an ink or suspension including solvents and polymeric binder, absent particulate filler, but having a dielectric polymeric particulate, can be printed to surround the second dielectric layer on four sides within the plane of the dielectric layer. In an example, the second dielectric layer and at least a portion of the insulative layer can be printed concurrently.

To form a multilayer capacitive element, the layering process can be repeated. Returning to 704, an additional electrode layer can be printed over the second dielectric layer. In an embodiment, the process can be repeated until at least about 500 layers are printed, and more particularly, at least about 1000 layers are printed, such as at least about 2000 layers.

In an exemplary embodiment, the layers are printed with a continuous stream printer. As the ink is deposited, it can be heated by an energy source, such as an infrared energy source. Heating the ink as it approaches a work piece can evaporate a portion of the solvent, increasing the viscosity of the ink before it contacts the work piece. The increased viscosity can reduce the spread of the ink and variations in the thickness of the layer. Additionally, the energy source can remove portions of binder from the layer by thermal decomposition. Further, the energy source can sinter other portions of the binder. In an embodiment, the energy source can provide sufficient energy to sinter the layer, increasing the density of the layer. In particular, the heat generated by the energy source is not sufficient to degrade the permanent polymer binder or the dielectric polymer particulate.

Alternatively, a gas, such as a hot gas, can be directed over the deposited layers to evaporate solvent and decompose burn-out binders. For example, the gas can be clean dry air, nitrogen, or a noble gas. The gas can be heat to a temperature of 50° C. to 150° C.

In addition to or alternatively, the capacitive element can be heat treated or further heat treated after a plurality of layers, such as after substantially all the layers, are printed, as illustrated at 712. In particular, the capacitive element can be hot isostatically pressed, such as at a pressure of at least 80 bar, for example, between 80 bar and 120 bar. The temperature can be at least about 150° C., or, in particular, at least about 165° C., such as between about 165° C. and about 215° C., or between about 170° C. and about 200° C. Alternatively, when the dielectric material includes a vitreous coating or when a vitreous glass insulation material is used, the temperature can be at least about 400° C., such as at least about 500° C., at least about 700° C. or even, at least about 900° C.

Further, the capacitive element can be cut, as illustrated at 714, and electrical connections applied to the electrodes, as illustrated at 716. For example, when the cathodes are offset from the anodes, as described above in relation to the first and second electrode layers, a single connection can be applied to a first side of the capacitive element to connect the cathodes, and a single connection can be applied to a second side of the capacitive element to connect the anodes. For example, the first and second sides can be dipped in a bath of molten metal. Alternatively, electrical connections can be established with a conductive adhesive.

Optionally, the multilayer capacitive element can be polarized, as illustrated at 718. For example, the capacitive element can be heated to a temperature of at least about 150° C., or, in particular, at least about 165° C., such as between about 165° C. and about 215° C., or between about 170° C. and about 200° C. In addition, a voltage difference of at least 2000 V, such as at least 3000 V, or even at least 3750 V is applied between the anodes and cathodes after heating.

Further, a set of the multilayer capacitive elements can be packaged into a capacitive storage device, as illustrated at 720. For example, more than one component can be electrically coupled and secured in a single physical arrangement to form an electrical storage device. In particular, several components can be placed in a housing that includes electrical contacts that couple the components in parallel or serial arrangements, or combinations thereof, to form the electrical storage device.

In an alternative process, the inks can be used to spin coat successive layers. Patterned layers can be spin coated over a substrate or other layers. Following application of the layers, the capacitive elements can be further consolidated or pressed. In an example, the capacitive elements can be heated and pressed. For example, the capacitive elements can be heated to a temperature near or exceeding the melting point of the polymeric material. In an example, the capacitive element can be heated to a temperature of at least about 150° C., or, in particular at least about 165° C., such as between about 165° C. and about 215° C., or between about 170° C. and about 200° C.

In another example, the layers of the capacitive elements can be coated, for example, spin coated onto a substrate or other layers. In the spin coating process, a solution of dispersed or dissolved solids is injected onto a static or spinning substrate and spun at high speeds until the solvent evaporates leaving behind a thin uniform layer of CMBT powders immersed in a polymer material matrix. For capacitor layers, a polymer such as PET, PC, PP, PE, PVC, PVDF, PMMA, polyvinyl alcohol (PVA), PEN, PPS, or any other polymer with acceptable electrical characteristics is dissolved in an appropriate solvent. Examples of solvents are hexafluoroisopropanol (HFIP) or phenol for PET, pyridine for PC, N, and N-dimethylformamide for PVDF. The choice of solvent has an effect on the final capacitor through viscosity and vapor pressure. The thickness of a spin coated layer is directly proportional to the viscosity of the polymer solution. The viscosity can also be adjusted by varying the polymer:solvent ratio and varying the CMBT:polymer ratio. The vapor pressure of the solvent affects the spin coating process by changing the speed and time the substrate must spin in order to achieve the desired layer thickness as well as whether or not a curing step is necessary.

After the polymer is dissolved in the solvent, CMBT powder is dispersed into the solution through high turbulence mixing. The CMBT powder may be coated with a thin layer of aluminum oxide or other coating and/or an amphiphilic agent to promote dispersion in the polymer matrix or a combination of both with the amphiphilic agent being the last coating. Amphiphilic agents such as, but not limited to, amino propyl triethoxysilane, vinyl benzyl amino ethyl amino propyl trimethoxysilane, methacryloxypropyl trimethoxysilane, glycidoxypropyl trimethoxysilane, phenyl trimethoxysilane, or any combination thereof, are chosen such that the organic group is compatible with the polymer into which the CMBT powder is being dispersed. Alternatively, the trialkoxysilane functional group can be substituted with a phosphonic, sulfonic, or carbonic acid group.

In an example, the dispersion can include 30% and 70% by weight of the solvent, such as 40% to 60% solvent. In addition, the dispersion can include 10% to 50% by weigh of the polymer, such as 10% to 40%, or 10% to 30% by weight. Further, the dispersion can include 20% to 60% by weight of the ceramic powder, such as the CMBT powder, such as 30% to 60%, or 40% to 60% by weight. In particular, the volume ratio of the polymer component to the powder of 0.6 to 1.5, such as 0.6 to 1.0, or 0.6 to 0.8. The composition can also include an amphiphilic agent in an amount of 0% to 10%, such as 0.1% to 8%, or 0.5% to 5.0% by weight based on the total composition.

The combined polymer/solvent, polymer, and amphiphilic agent coated CMBT powder dispersion is then injected onto a substrate held rigidly onto the spin coater. The substrate itself can be either flexible, such as a metal foil, or rigid, such as a metal coated glass or solvent resistant plastic. The amount of dispersion injected is dependent on substrate size and shape, but only the minimum needed to cover the substrate is used. Excess dispersion is flung from the edges of the substrate during the first stage of the spin coating. During the remainder of the spin coating process, the solvent evaporates leaving a thin film of polymer/CMBT powder which is being stretched by the angular motion. The speed and time of the spinning affect the thickness of the layer, i.e., a faster spin speed and longer time produce a thinner layer. A curing step, such as but not limited to placing the layer in an oven, may be used after the spinning process to completely remove the remaining solvent. The temperature, time and other conditions of the curing step are chosen based on the properties of the polymer.

In particular, spin coating provides cohesive layers exhibiting uniformity and continuity, for example, free of discontinuities and gaps.

In an example, spin coating can be performed using the ink formulations described above. Alternatively, solvents, such as hexafluoroisopropanol can be used in conjunction with PET polymers.

Single layers formed through spin coating can be combined to create a multilayer capacitor. For example, if the substrate used is conductive, layers can be cut and stacked to form a multilayer capacitor. Alternatively, electrodes can be patterned and screen printed or pressed onto the original layer and a second layer is spun coat on top of the electrode. Such a process is repeated until the desired number of layers has been formed. Subsequently, the capacitor is cut and the electrodes are capped. Capacitors formed through the above process can have layers ranging from 3 to 16 μm and dielectric strengths of at least 100 V/μm before film densification with the maximum being in the range 1200 V/μm level after film densification.

Following application of one or more layers, the layers can be pressed, such as roll pressed to remove bubbles or air as identified above. Such pressing can be performed after each layer is applied, following the application of several layers, after formation of all layers, or any combination thereof. In addition, the capacitive elements can be isostatically pressed following formation.

For example, the layers can be densified. Solvent evaporation can leave micro voids in the layers. Such micro voids can be removed to improve breakdown voltage.

When the solvent is removed in the spin coating process micro voids can remain in the polymer/ceramic particle layer. A capacitor that has air voids can exhibit a low voltage breakdown if the void is larger enough and if the applied voltage is higher than the 33 kV/cm, which is the theoretical breakdown of air. For example, a 1 μm air void can ionize at around 3.3 V, lowering the breakdown voltage of the capacitor.

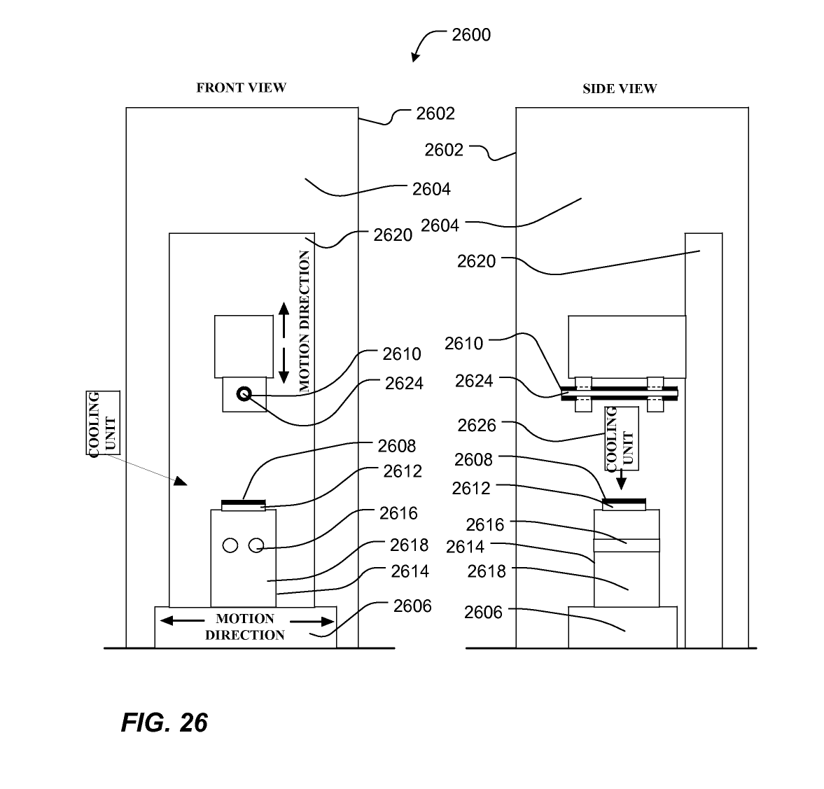

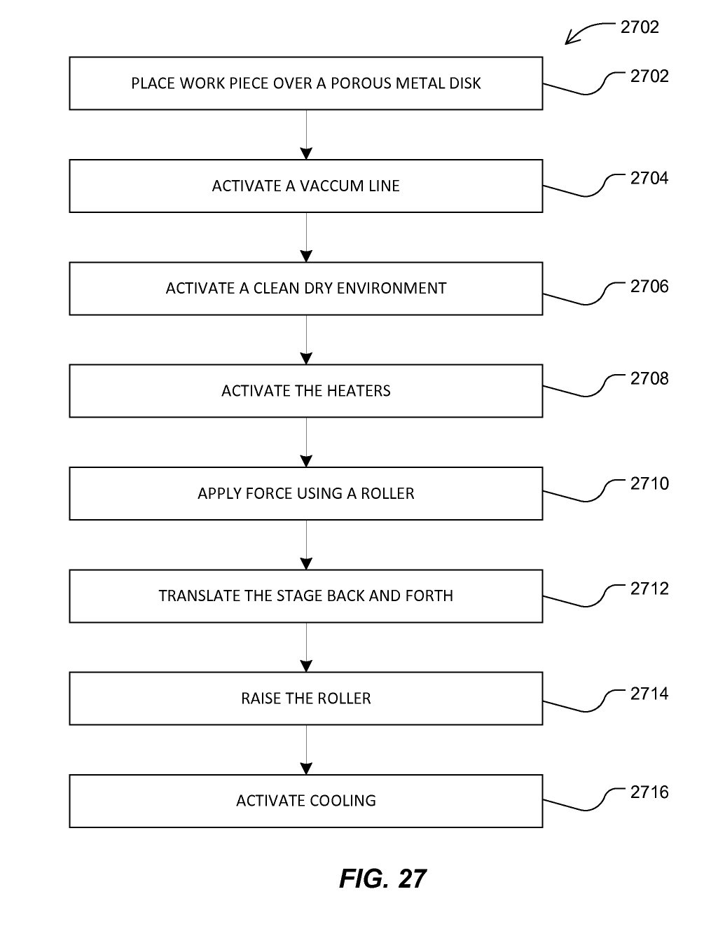

To densify the layers, a hot rolling process can be used. FIG. 26 includes an illustration of an apparatus 2600 for performing hot rolling processing. FIG. 27 includes an illustration of an exemplary method 2700 for hot rolling processing.

The apparatus 2600 includes a containment housing 2602, which can be closed to provide a low humidity inert atmosphere 2604, such as a low humidity nitrogen atmosphere. The apparatus 2600 also includes a translation stage 2606 for providing movement of a work piece 2608 relative to a roller 2610. The work piece 2608 can be positioned on a porous metal disk 2612 that is secured to a heated stand 2614 disposed on the translation stage 2606. The heated stand 2614 can include heaters 2616 and a vacuum line 2618. The vacuum line 2618 can apply a vacuum through the porous metal disk 2612 to hold the work piece 2608 in place.

The apparatus 2600 can also include a bearing force delivery unit 2620 to deliver a force to the work piece 2608 that is approximately perpendicular to the movement of the translation stage 2606. The roller 2610 is coupled to the bearing force delivery unit 2620 via bearing housings 2622. The roller 2610 can be coated with a release coating. In addition, the roller 2610 can include a heater 2624.

Turning to FIG. 27, the method 2700 includes placing a work piece 2608 including a composite dielectric layer over a support, such as the porous metal disk 2612, as illustrated at 2702. A vacuum line 2618 is activated to secure the work piece 2608 to the support, as illustrated at 2704, and a clean dry environment 2604 is activated, as illustrated at 2706. For example, the containment housing 2602 can be closed and a source of clean dry nitrogen can be supplied within the housing 2602. In addition, heaters, such as the roller heater 2624 and the support heater, such as heaters 2616, can be activated, as illustrated at 2708. The heaters 2624 or 2616 can be heated to a temperature in a range of 190° C. to 260° C., such as a range of 200° C. to 250° C., or even a range of 220° C. to 250° C.

Once the heaters provide the desired temperature, a force can be applied to the work piece 2608 using the roller 2610, as illustrated at 2710. For example, the bearing force delivery unit 2620 can move the roller 2610 into place and can apply the desired force to the work piece 2608. For example, the roller 2610 can apply a pressure in a range of 10 psi to 100 psi, such as a range of 10 psi to 80 psi, or even a range of 20 psi to 70 psi.

While the roller 2610 is applying force to the composite layer, the translation stage 2606 moves the work piece 2608 in a direction approximately perpendicular to the force applied by the roller 2610, as illustrated at 2712. The translation stage 2606 moves the work piece 2608 to compress its full domain at least once, such as at least twice, at least three time, or even at least four times.

Subsequently, the roller 2610 can be raised, as illustrated at 2714, and the work piece 2608 can be cooled, as illustrated at 2716. A cooling unit 2626 can reduce the temperature of the work piece 2608, for example, by applying a cool gas, such as nitrogen to the work piece. In particular, rapid cooling of the work piece 2608 can limit crystallization in the polymer matrix of the composite material. As such, the polymer matrix can be predominantly amorphous, providing for improved mechanical properties and improving durability of the device.

Additional layers can be laminated, printed, or otherwise formed over the composite layer. For example, multiple layers including dielectric layers between electrodes can be formed. Alternatively, constructions including an electrode and a dielectric layer can be formed and subsequently laminated to other similar layers.

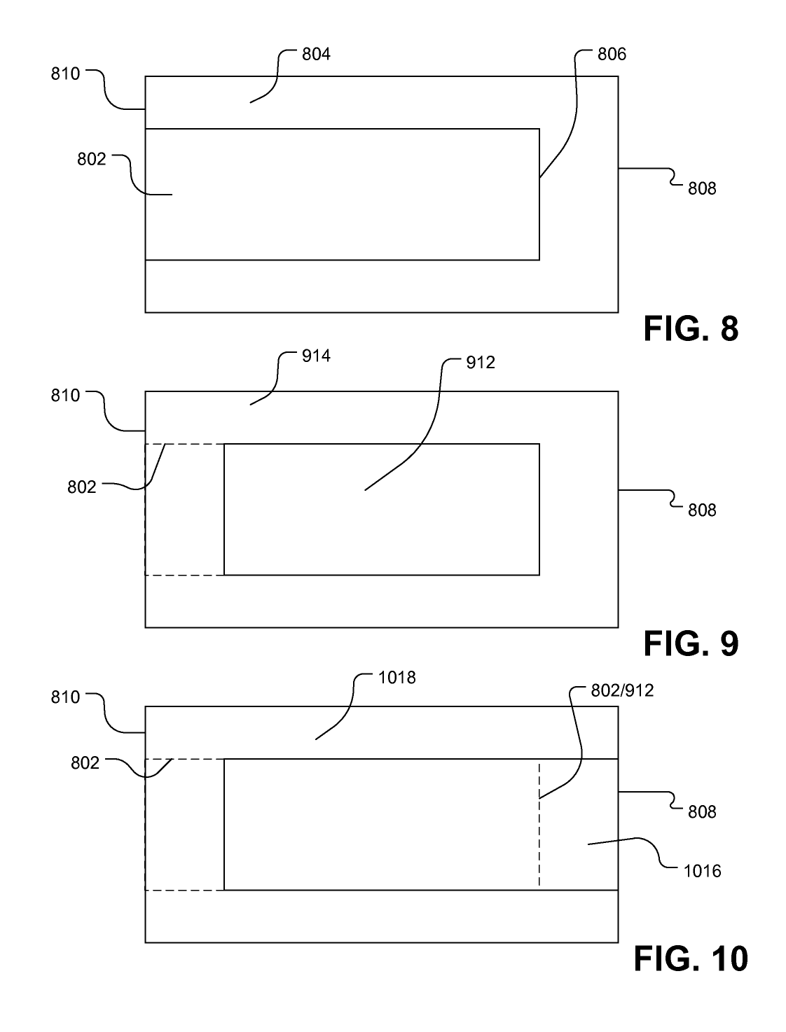

In an exemplary embodiment, the above methods and devices can be used to form patterned layers of elements of a capacitive storage device. Patterned layers describe the nature of each layer including, within the layer, a pattern of deposited materials. Patterned layers are deposited on top of one another to form capacitive elements of the electrical storage device. For example, FIG. 8, FIG. 9, and FIG. 10 include illustrations of adjacent layers of a multilayer energy storage device. As used herein, longitudinal refers to the longest orthogonal dimension of a layer, transverse refers to the second longest orthogonal dimension and thickness refers to the third longest orthogonal dimension. For example, FIG. 8 includes an illustration of an exemplary electrode layer (e.g., an anode layer), FIG. 9 includes an illustration of an exemplary dielectric layer, and FIG. 10 includes an illustration of an exemplary opposite electrode layer (e.g., a cathode layer). As illustrated at FIG. 8, within the electrode layer, an electrode 802 is surrounded by an insulative portion 804, such as a dielectric polymeric portion. Alternatively, the dielectric polymeric portion 804 can be substituted with a vitreous glass or a high voltage polymer portion. In particular, the electrode 802 extends from a first end 810 of the electrode layer to a position 806 that is spaced apart from the second end 808 of the electrode layer. As illustrated, the electrode 802 forms a rectangular shape that is surrounded on three sides by the insulative portion 804.

As illustrated at FIG. 9, a dielectric layer includes a dielectric ceramic portion 912 surrounded by an insulative portion 914, such as a dielectric polymer portion, on four sides. The dielectric ceramic portion 914 can be disposed over a portion of the underlying electrode 802. Further, the dielectric ceramic portion 912 is spaced away from the edges 808 and 810 of the layers. Alternatively, the dielectric polymer portion 914 can be replaced with a vitreous glass portion.

In particular, the dielectric ceramic portion includes a composite including a matrix material and the dielectric ceramic particulate. In an example, the dielectric ceramic particulate forms 70 wt % to 99 wt % of the composite. For example, the composite can include 85 wt % to 98 wt %, such as 90 wt % to 97 wt %, or even 93 wt % to 96 wt % of the dielectric ceramic particulate. In addition, the composite can include the matrix material, such as a polymeric matrix material, in an amount of 1 wt % to 20 wt %, such as 2 wt % to 15 wt %, 3 wt % to 10 wt %, or 4 wt % to 7 wt %.

As further illustrated in FIG. 10, a second electrode 1016 can be printed within a layer and can be surrounded on three sides by an insulative portion 1018, such as a dielectric polymer portion. The second electrode 1016 can contact the edge 808 and can be spaced from the edge 810 in contrast to the first electrode 802. As such, the second electrode 1016 is offset from the first electrode 802. Alternatively, the dielectric polymer portion 1018 can be replaced with vitreous glass portion.

The multiple-layer capacitor configuration illustrated in FIG. 8, FIG. 9 and FIG. 10 can be utilized in the fabrication of capacitors for an energy-storage device. For example, the patterned layers can be printed using a single print head. Alternatively, more than one print head can be used. In an example, the layers can be repeated until at least about 500 layers are formed, and in particular, at least about 1000 layers are formed, such as at least about 2000 layers.

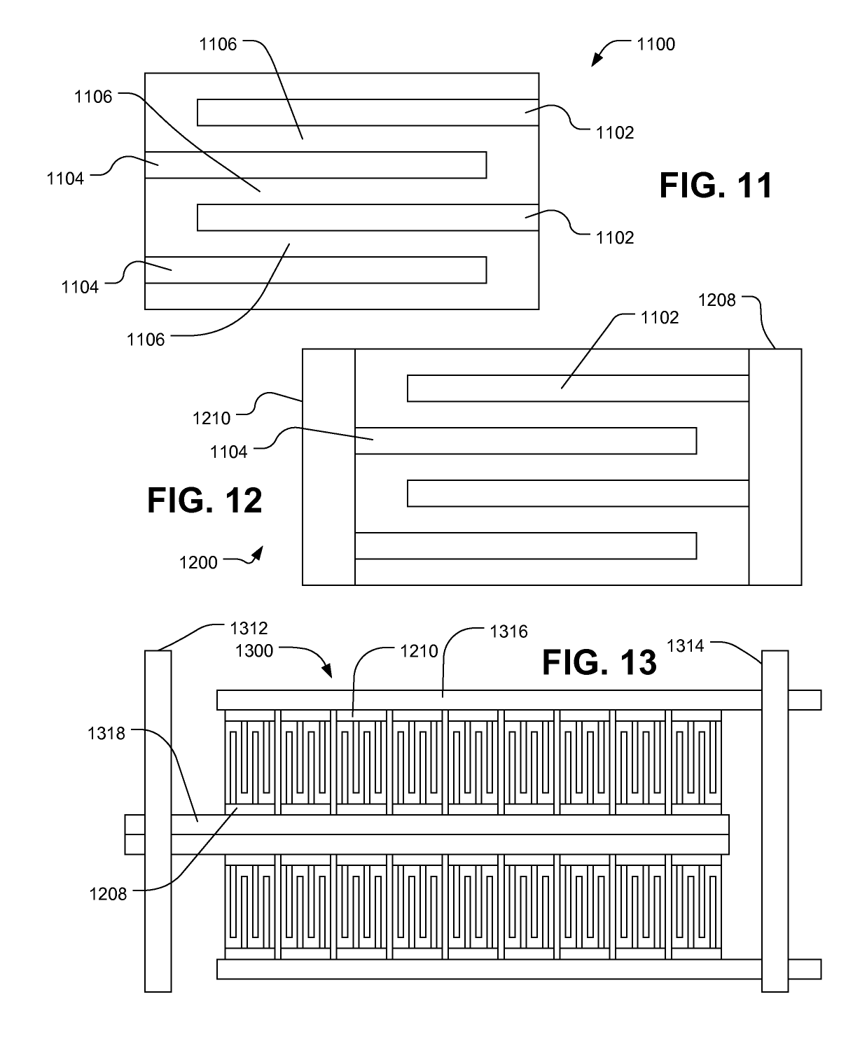

When viewed in cross-section as illustrated a FIG. 11, the element 1100 includes electrodes 1102 offset from electrodes 1104. The dielectric material 1106 is disposed between the electrodes 1102 and 1104. The electrodes 1102 or 1104 can have a thickness in a range of 0.5 micrometers to 20 micrometers, such as a range of 0.5 micrometers to 10 micrometers, a range of 0.5 micrometers to 5 micrometers, or a range of 0.5 micrometers to 2 micrometers. The distance between electrodes 1102 and 1104 can be in a range of 1 micrometer to 50 micrometers, such as 5 micrometers to 25 micrometers, a range of 5 micrometers to 18 micrometers, or a range of 9 micrometers to 12 micrometers.

A component 1200 illustrated in FIG. 12 includes the element 1100 and component electrodes 1210 and 1208. The component electrode 1210 can electrically connect the electrodes 1104, and the component electrode 1208 can electrically connect the electrodes 1102. The component electrodes 1210 and 1208 can be formed by dip coating, spray coating, applying a conductive paste, or any combination thereof or fabricated from metal such as copper, aluminum, or nickel and bonded to the component with a silver filled epoxy paste. For example, the edges of the component 1200 can be dipped into a metal bath, such as bath including aluminum, copper, an alloy, or any combination thereof. In another example, a conductive paste can be applied to the edges of the component 1200. The component electrodes 1210 or 1208 can have a thickness in a range of 10 micrometers to 2 mm, such as a range of 50 micrometers to 1 mm, or a range of 100 micrometers to 1 mm.

Following formation, the component can be polarized. For example, the component can be heated to a temperature of at least about 150° C., or, in particular at least about 165° C., such as between about 165° C. and about 215° C., or between about 170° C. and about 200° C. In addition, a voltage difference of at least 2000 V, such as at least 3000 V, at least 3500 V, or even at least 3750 V is applied between the anodes and cathodes after heating. After polarizing, the component can be rapidly cooled to ensure that the polymer retains an amorphous state.

Components, such as component 1200 can be incorporated into an energy storage device 1300 as illustrated in FIG. 13. For example, component electrodes (e.g., component electrodes 1210) can be electrically connected with device electrodes 1316, and component electrodes (e.g., component electrodes 1208) can be electrically connected to device electrodes 1318. The device electrodes 1318 can be electrically connected to pole 1312, and the device electrodes 1316 can be electrically connected to pole 1314.

The energy storage device 1300 can be placed in a casing and electronic controls and fuses assembled therewith, thereto, or therein. Further, the device can be coupled to a load or a recharge port.

In an example, the energy storage device has a desirable capacity, expressed as a specific energy density by weight or an energy density by volume. For example the electrical energy storage device has a specific energy of at least 450 W·h/kg based on weight or an energy density of at least 750 W·h/L based on volume. The dielectric ceramic particulate has a relative permittivity of at least 60,000. In an example, the dielectric ceramic particulate includes a composition-modified barium titanate. Further, the electrical energy storage device can have a breakdown voltage of at least 500 V/μm, such as at least 1000 V/μm and can have a maximum working voltage of at least 1100 V, such as at least 2000 V, at least 3500 V, or even at least 5000 V. Using the combination of methods herein, higher or lower energy densities, specific energies, relative permittivity or voltage breakdowns can be fabricated to meet demands of various applications.

For example, the energy storage device can have a specific energy of at least 0.45 kW·h/kg, such as at least 0.6 kW·h/kg, at least 0.85 kW·h/kg, or even at least 0.99 kW·h/kg. In particular, the energy storage device can have a specific energy by weight of at least 1.15 kW·h/kg, such as at least 1.35 kW·h/kg, at least 1.5 kW·h/kg, at least 1.8 kW·h/kg, at least 2.0 kW·h/kg, or even at least 2.5 kW·h/kg. In another example, the energy storage device can have an energy density by volume of at least 750 W·h/liter, such as at least 2277 W·h/liter, at least 2600 W·h/liter, at least 3300 W·h/liter, or even at least 4200 W·h/liter. In particular, the energy storage device can have an energy density by volume of at least 5000 W·h/liter, such as at least 5600 W·h/liter, at least 6700 W·h/liter, at least 7500 W·h/liter, or even at least 8300 W·h/liter. In an example, the specific energy may be not greater than 30 kW·h/kg and the energy density may be not greater than 152.9 kW·h/liter. Specific energy and energy densities are determined absent outer casings and associated electronics at maximum voltage before breakdown.

In a further example, the energy storage device has a desirable breakdown voltage for the device as a whole where the dielectric layer has a thickness of 10 μm. For example, the breakdown voltage can be at least 1200 V, such as at least 2000 V, at least 2500 V, at least 3000 V, or even at least 3500 V. In a particular example, the breakdown voltage is at least 3750 V, such as at least 4000 V. The breakdown voltage for the dielectric composite can be at least 100 V/μm, such as at least 200 V/μm, at least 400 V/μm, at least 500 V/μm, at least 600 V/μm, at least 700 V/μm, at least 800 V/μm, at least 1000 V/μm, at least 1200 V/μm, at least 2000 V/μm, or even at least 3000 V/μm. The operating voltage may be selected to be 150 V/μm less than the breakdown voltage.

For example, if the breakdown voltage is at least 500 V/μm, the operating voltage is at least 350 V/μm, if the breakdown voltage is at least 1000 V/μm, the operating voltage is at least 850 V/μm, and if the breakdown voltage is at least 2000 V/μm, the operating voltage is at least 1850 V/μm.

In an additional example, the energy storage device has a low leakage rate, defined as the percent loss in voltage over a 12 month period when charged to its operating voltage, of not greater than 5%, such as not greater than 3%, not greater than 2% not greater than 1%, not greater than 0.2%, or even not greater than 0.02%.

In another example, the energy storage device may be cycled without loss in capacity. For example, the energy storage device can be cycled from 100% maximum charge voltage to fully discharge voltage and charged back to 100% maximum charge voltage more than 10⁶ times, losing less than 5% energy storage capacity, such as less than 2% energy storage capacity, or even less than 1% energy storage capacity. Herein, such energy storage capacity loss is termed “cycle loss.”

In addition, the energy storage device has a desirable charge rate and discharge rate. Due to the low internal dc resistance of the device, which can be in the range of micro-ohms, the discharge and charging rates are limited only by the capability of the circuits and energy sources providing this function. The power loss of a resistor is equal to the formula I²R, where I identifies the current flowing through the resistor and R is the resistance of the component. The internal resistance of the capacitor can be in the range of 20 μΩ. If the charging or discharging current is 1000 amps, the power loss in the capacitor will be 20 watts. If the output voltage is 400 V, the total output power would be 400,000 watts. The total loss would be 0.005% which is insignificant to the efficiency of the device. The capacitor fabrication can be adjusted to provide a lower input dc resistance and is dependent on the number of capacitive layers the thickness and material of the anode and cathode metal layers.

For example, the discharge rate of the energy storage device, defined as the maximum discharge rate without causing damage to the device, can be at least 50 amps, such as at least 75 amps, at least 85 amps, at least 100 amps, at least 500 amps, or even at least 1000 amps. In an example, the charge rate, defined as the maximum rate the energy storage device can accept charge without damage, is at least 50 amps, such as at least 75 amps, at least 85 amps, or even at least 100 amps. In another example, the charge rate can be expressed as a charge index, defined as the time to charge the energy storage device to capacity, of not greater than 15 minutes, such as not greater than 10 minutes, not greater than 5 minutes, or even less than 1 minute, such as not greater than 30 seconds, or not greater than 15 seconds. Such is particularly desirable in energy storage devices having a capacity of at least 1 kW·h.

To charge the electrical ESU or deliver power (energy) to the user from the electrical ESU, fabricated using capacitors as indicated above and high density packaged onto printed circuit boards, converter circuits can be utilized. The charging method can also be performed with the use of specialized circuits connected to power sources such as the utility grid standard 115 V or 220 V 60 hertz outputs or special energy sources, such as electrical ESU-to-electrical ESU with connective circuitry, motor generators, photovoltaic systems, wind turbine systems, or fuel cells. Such energy sources represent a partial set of energy sources and many other types of energy sources can be utilized to provide energy to the electrical ESUs. Converter circuit can be used to charge or provide a specified voltage at a rated output power. Exemplary converter circuits include a full bridge buck converter, a half-bridge buck converter, a forward bridge buck converter, a fly back buck converter, a push-pull buck converter, a synchronous switching, a buck converter, or any combination thereof. Exemplary topographies also include resonate topographies derived from the above converters, such as a LLC Buck Converter, PSFB Buck Converter, etc., or any combination thereof.

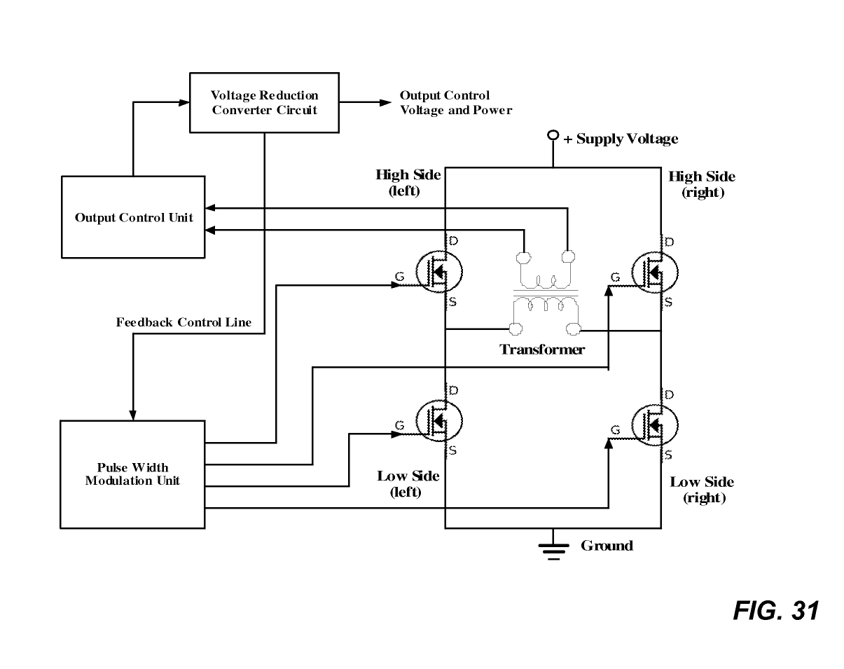

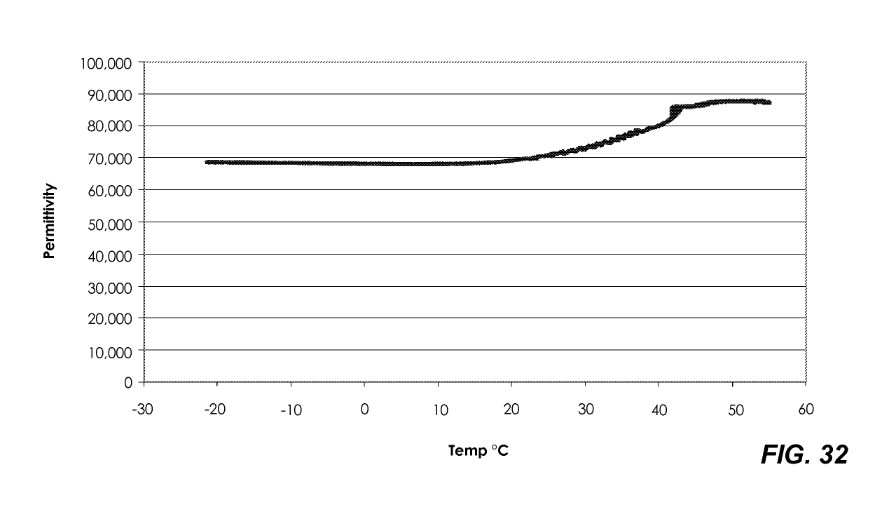

In an example, the output voltage can be configured in the range of +150 V to +5 V. A wider output voltage range can be provided if the application requires higher or lower output voltages with minor changes to the converter circuit architecture as indicated in FIG. 31 below. The supply voltage can be supplied by an electrical ESU as indicated above. For example, for low voltage uses, the output voltage can be between 5V and 15V. In a medium voltage application, the output voltage can be between 20V and 80V. Alternatively, circuitry can be configured to provide line power, such as between 100 V and 150V. However, circuitry can be formed to provide high voltage output, such as between 250V and 950 V.

Furthermore, the energy storage device can be configured for small power consumers. As such, the energy storage device can have a capacity of at least 1 W·h, such as at least 4 W·h, at least 10 W·h, at least 25 W·h, or even at least 50 W·h. In addition, the energy storage device can be configured for medium power consumers and can have a capacity of at least 100 W·h, such as at least 500 W·h, or even at least 1 kW·h. In a further example, the energy storage device can be configured for large power consumers and can have a capacity of at least 5 kW·h, such as at least 10 kW·h, at least 25 kW·h, at least 50 kW·h, or even at least 100 kW·h. However, lower or higher energy storages can be fabricated depending of the application.

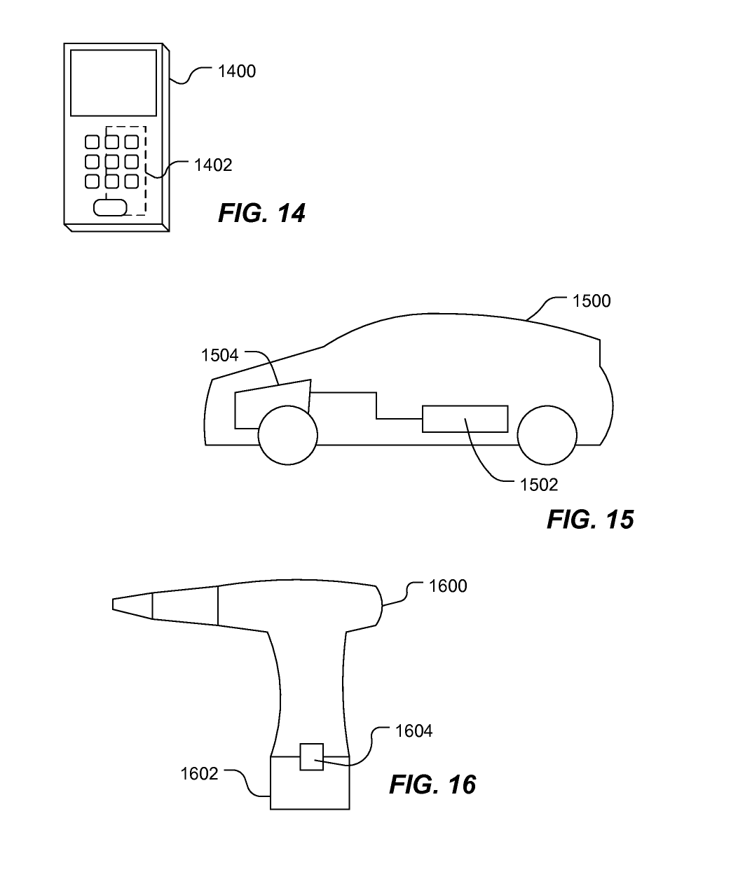

In particular, the energy storage device can be used to supply electrical energy in a variety of uses. The dimensions and capacity of the energy storage device can be adjusted to match the desired use. For example, an energy storage device 1402 can be configured for use in a portable electronic device, such as a phone, portable computers, or gaming device, as illustrated in FIG. 14. In an embodiment the portable electronic device has a mass not greater than 5 kg, not greater than 2 kg, or not greater than 0.5 kg. In an example, the electrical energy storage device 1402 has a capacity of at least 1 W·h or higher as needed. In another example illustrated in FIG. 15, a vehicle 1500, such as a car or truck, can include an electrical energy storage device 1502 coupled to an engine 1500. Alternatively, the vehicle can be a motorcycle, a moped, a train, an off-road vehicle, a vehicle with treading, or any combination thereof. In an example, the electrical energy storage devices hooked up in parallel 1502 has a capacity of at least 15 kW·h or higher as needed. In a further example illustrated in FIG. 16, an electrical energy storage device 1602 can be used to power a tool 1600. For example, the tool can be a drill, a saw, a flashlight, or any combination thereof. In a particular embodiment, the tool 1600 can be a handheld tool. In an example, the energy storage device 1602 can have a capacity of at least 100 W·h or higher as needed. In a further example, the energy storage device 1602 is interchangeable, defined herein as including a quick release mechanism 1604 to permit substitution of one storage device for another storage device.

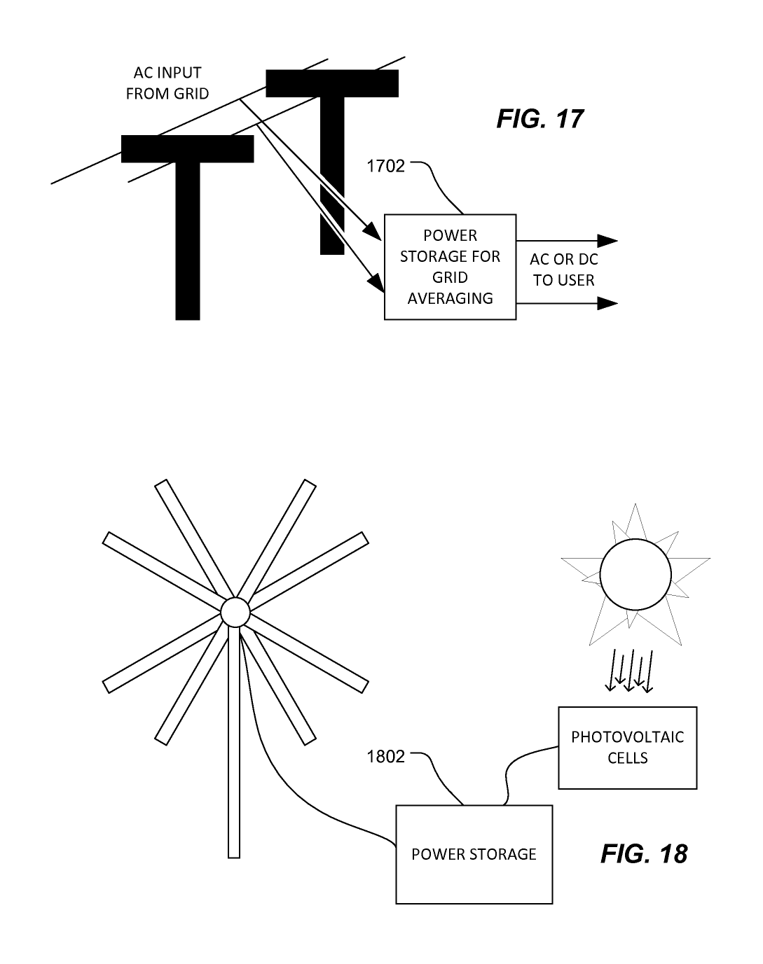

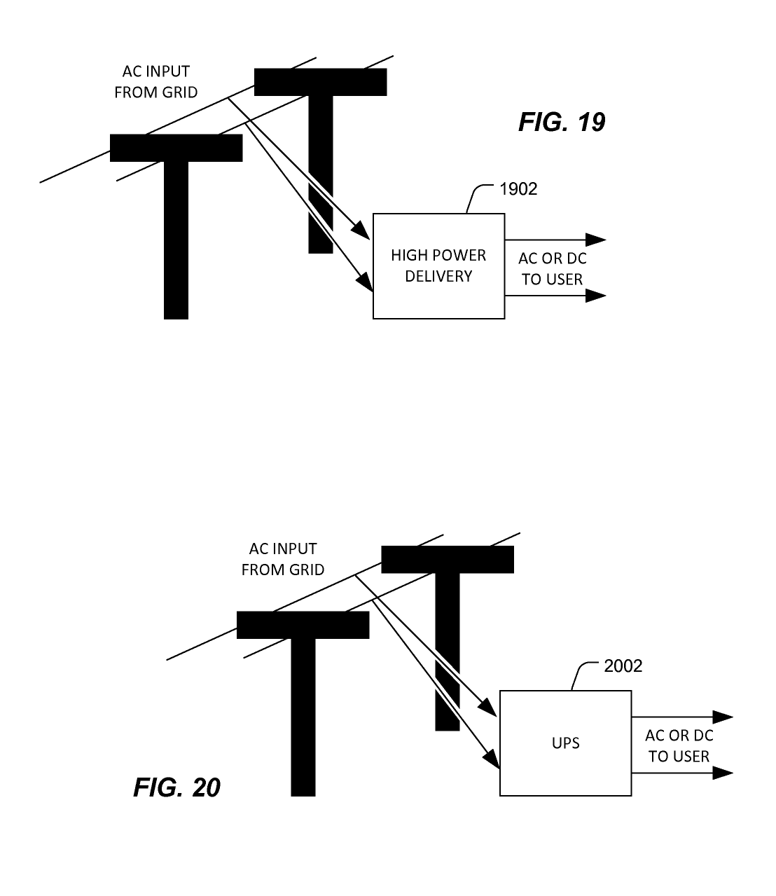

In yet another example illustrated in FIG. 17, an electrical energy storage devices connected in parallel 1702 can be used to provide utility grid power averaging has a capacity of at least 500 MW·h or higher if needed. In yet another example illustrated in FIG. 18, an electrical energy storage devices connected in parallel 1802 can be used to provide output energy stabilization for wind and solar plants and can have a capacity of at least 500 MW·h or higher. In a further example illustrated in FIG. 19, an electrical energy storage devices connected in parallel 1902 can be used to provide localized high energy delivery capability for energy delivery stations of electric vehicles and can have a capacity of at least 50 MW·h or higher. In yet another example illustrated in FIG. 20, an electrical energy storage device 2002 can be used to provide uninterruptable power system with localized electrical energy storage and can have a capacity of at least 200 W·h or higher. In an additional example, an electrical energy storage devices connected in parallel can be used to provide critical electrical energy storage for critical military programs and can have a capacity of at least 10 W·h to 100 MW·h or higher.

In particular, a dielectric ceramic particulate having desirable properties, such as thermally stable high permittivity, can be formed from a set of precursor materials including chelates, that are precipitated in a high turbulence reactor, treated in a high pressure hydrothermal treatment vessel, and decomposed and calcined using specific method. The dielectric ceramic particulates can be optionally coated and dispersed in a polymer matrix material to form a dielectric composite, which can be used to form elements of an electrical energy storage device/unit. The energy storage device has desirable energy density, expressed by weight or by volume, and can be configured for a variety of uses.

### EXAMPLES OF PARTICULAR EMBODIMENTS

Unless otherwise specified, relative permittivity is determined by pressing a particulate or composite to a thickness of approximately 10 μm between copper or aluminum electrodes having an area of approximately 0.73 cm². The relative permittivity is determined at a temperature within a temperature range of −20° C. to +55° C. using a Agilent 4263B LCR meter with their 16451B dielectric test fixture at a frequency of 100 Hz.

### Example 1

Two reactant streams are introduced into a tube reactor. The first stream includes barium nitrate, organic titanium chelate available under the Tradename Tyzor® from DuPont™, trace amounts of other metal nitrates and metal or oxometal citrates, including five additional metal constituents, such as indicated in Table I, or being selected from calcium, zirconium, yttrium, manganese, neodymium, tin, zinc, vanadium, niobium, tantalum, molybdenum, tungsten, lanthanum, hafnium, or chromium. The second stream includes a mixture of tetramethylammonium hydroxide and tetramethylammonium oxalate. The first stream has a flow rate about four times greater than the flow rate of the second stream. The tube reactor has a turbulence intensity of approximately 8.3×10¹⁰ cm/s³ and a Reynolds number of approximately 78,000. The pH of the solution is maintained between 10 and 12 and the temperature is approximately 95° C. for both streams. The pressure in both tanks is 100 psi and the metering valves associated with each tank is set to provide the desired flow rates as indicated above.

The particulate material formed in the reactor is hydrothermally treated using a pressure tank with a rating of 300 psi at 150° C. The top of the tank is chilled to condense water vapor, thereby ensuring the solution volume remains constant for the duration of the treatment. When the liquid stream including the particulate is delivered to the tank, the process parameters are set at 250 psi and 150° C. for 6 hours. Tetramethylammonium hydroxide is added to maintain the pH in a range of 10 to 12.

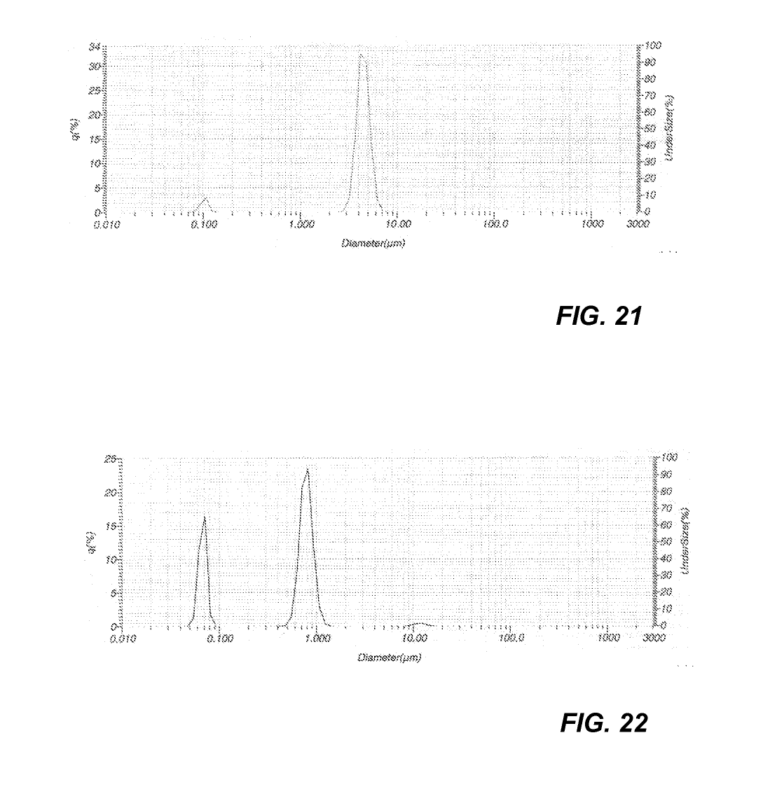

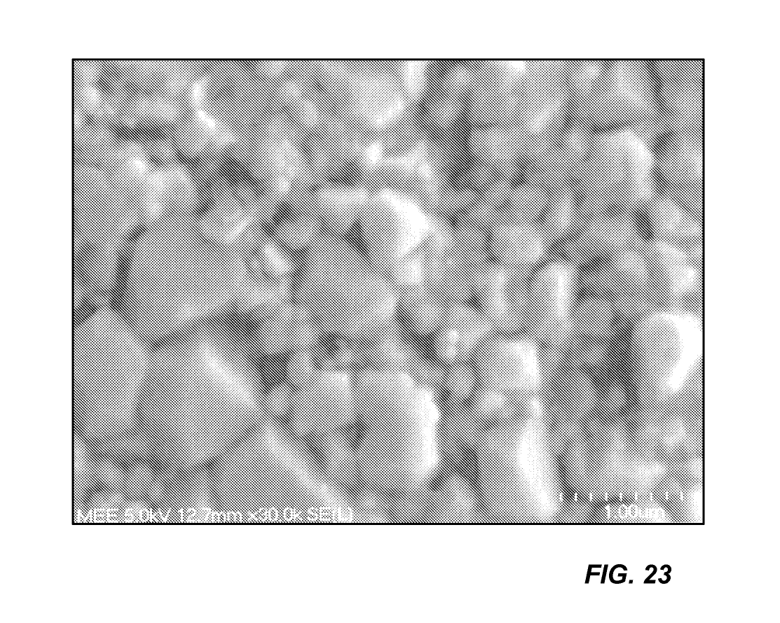

Following hydrothermal treatment, the particles are washed, concentrated in a centrifuge, flash dried, and subjected to decomposition and calcining at temperatures in a range of 25° C. to 1050° C. in the assemblies illustrated in FIG. 1 and FIG. 2. FIG. 21 illustrates the particle distribution following hydrothermal treatment. As illustrated, the mean particle size is approximately 4.24 μm and the standard deviation is approximately 1.16 μm. FIG. 22 illustrates the particle size distribution following decomposition and calcining. The mean particle size is 0.67 μm and the standard deviation is 1.14 μm.

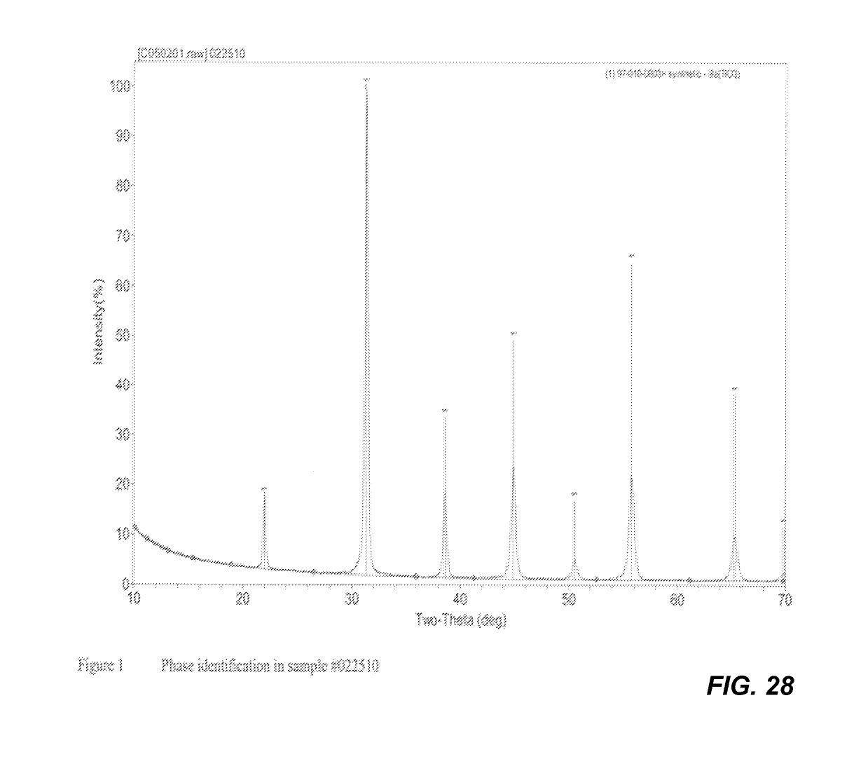

To determine percent yield, the composition-modified barium titanate powders are analyzed for composition and crystalline structure using an x-ray diffraction technique. FIG. 28 illustrates 100% homogeneity of the powders. The analysis indicates a cubic crystalline form, which means that the powders are in the paraelectric phase. The domain size is approximately 356 Å. The perfect homogeneity, cubic crystalline structure, and the paraelectric phase allow ultrahigh relative permittivity over a wide temperature ranges. As illustrated in FIG. 32, the relative permittivity reached 70,000 over a temperature range of −20° C. to 55° C. with no apparent reduction in relativity permittivity at the lower and higher temperatures.

### Example 2

For Example 2, streams 1 and 2 are the same as in Example 1. The two reactant streams are introduced into a tube reactor. The first stream includes barium nitrate, organic titanium chelate available under the tradename Tyzor® from DuPont™, and trace amounts of five other metal nitrates and metal or oxometal citrates, including metals selected from calcium, zirconium, yttrium, manganese, neodymium, tin, zinc, vanadium, niobium, tantalum, molybdenum, tungsten, lanthanum, hafnium, or chromium. The second stream includes a mixture of tetramethylammonium hydroxide and tetramethylammonium oxalate. The first stream has a flow rate about four times greater than the flow rate of the second stream. The tube reactor has a turbulence intensity of approximately 1.9×10⁷ cm/s³ and a Reynolds number of approximately 27,000. The pressure in both tanks is 100 psi and the metering valves associated with each tank is set to provide the desired flow rates as indicated above.

The particulate material formed in the reactor is hydrothermally treated using a pressure tank with a rating of 300 psi at 150° C. The top of the tank is chilled to condense water vapor, thereby ensuring the solution volume remains constant for the duration of the treatment. When the liquid stream including the particulate is delivered to the tank, the process parameters are set at 250 psi and 150° C. for 6 hours. The pH is maintained in a range of 10 to 12.

Following hydrothermal treatment, the particles are washed, concentrated in a centrifuge, flash dried, and subjected to decomposition and calcining at temperatures in a range of 25° C. to 1125° C. Following decomposition and calcining, the mean particle size is similar to the distribution illustrated in relation to Example 1. The relative permittivity (K) is in the range of 50,000 or higher over the temperature range of −20° C. to +55° C. or even a wider temperature range depending on the application.

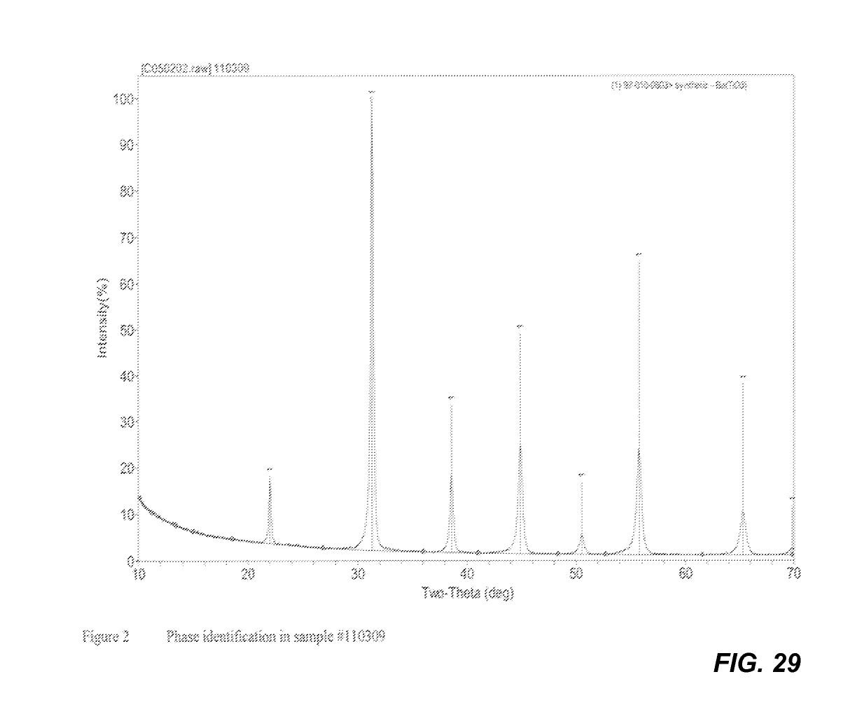

Such is contrasted with the relative permittivity of composition-modified barium titanate particulate reported in U.S. Pat. No. 7,033,406, namely 33,500, or reported in U.S. Pat. No. 7,466,536, namely 21,072. FIG. 29 indicates the x-ray analysis for the powders of Example 2, indicating 100% homogeneity of the powders. The analysis indicates a cubic crystalline form, which means that the powders are in the paraelectric phase. The domain size is approximately 304 Å.

### Example 3

A process similar to the process of Example 2 is performed using nine constituent metal ions. The nine constituents in the starting aqueous mixture range in concentration from 50 to several thousand ppm. The first stream includes barium nitrate, organic titanium chelate available under the Tradename Tyzor® from DuPont™, and trace amounts of other metal nitrates and metal or oxometal citrates, including seven other metal constituents, such as those indicated in Table I and additional components being selected from calcium, zirconium, yttrium, manganese, neodymium, tin, zinc, vanadium, niobium, tantalum, molybdenum, tungsten, lanthanum, hafnium, or chromium. After the powder production process is complete, the constituents range from undetectable concentrations to a maximum of 8.44 ppm.

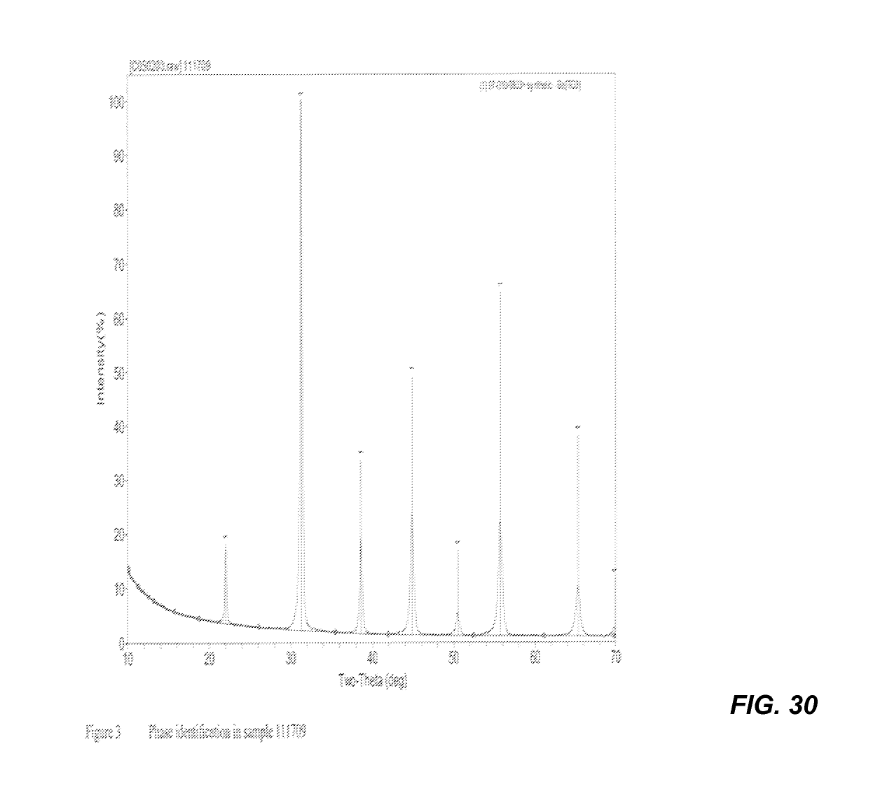

As described above, FIG. 21 and FIG. 22 indicate the effectiveness of the calcining system and process to reduce the particle size of the composition-modified barium titanate powder produced in Example 1 to the range of 0.6 μm to 0.8 μm. The particle size data is obtained by testing the composition-modified barium titanate powders on a Horiba laser scattering particle size distribution analyzer LA-950. FIG. 30 illustrates the data from an x-ray diffraction test of the powder produce in Example 3. The domain size is 303 Å. Such data indicates a cubic perovskite crystalline structure with the activating chemical removed. The Quantitative X-Ray Diffraction data indicate a removal of the activating chemicals below the testing threshold of ppb level, which indicates the effectiveness of the decomposition and calcining process, the decomposition and calcining system, and the powder processing steps leading up to this phase of powder production. Example 3 has nine constituents formed by:
Chelating chemicals allowing constituent multiple, up to nine, blending;
Activating chemical that allow effective precipitating of the constituents into composition-modified barium titanate powders;
High intensity blending of the activating chemicals and constituent chelating chemicals so the during the precipitating process the powder size is desirable;
A post powder hydrothermal high temperature/pressure activating process that assists in providing a 100% or near 100% homogeneous powder with a Cubic crystalline structure; and
Decomposition and calcining systems and process that assist in providing composition-modified barium titanate powder high purity, desired size, and desired Cubic crystalline structure.

In general, the combination of methods provides a desirable dielectric ceramic powder. FIG. 32 illustrates test data for Example 1 of relative permittivity over the temperature range of −20° C. to +55° C. In particular, the relative permittivity is at least 35000, such as at least 50000, at least 65000, at temperatures in a range of −20° C. to +65° C., such as a range of 0° C. to +35° C. Further, the relative permittivity can be at least 70000, or even at least 75000, at temperatures such as at least +35° C. In addition, the deviation from the +25° C. ambient temperature provides an improvement over the ceramic capacitor testing standards. The X7R ceramic capacitor standard specification is +15% and −15% over their specified temperature range, where as the present powders have −2.1% negative deviation, representing a major improvement in ceramic capacitor technology. The test system to measure the relative permittivity over the indicated temperature ranges is an Agilent 4263B LCR meter and fixture, Cincinnati Sub-Zero Products, Inc, a Micro Climate Unit, IET Labs, Inc., a CS-301 capacitance substituter, and an Omegaette HH 314 Humidity and Temperature Meter.

### Example 4

A composite layer is spin coated on an electrode. The ink includes 40% by volume CMBT and 60% by volume PET. The solvent is hexafluoroisopropanol and the combination of PET and CMBT is 44.5% by mass in solution.

The ink is spin coated onto a 3 μm aluminum film. The spin profile is 100 rpm for 3 seconds during which the solution is injected. Spin process continues at 100 rpm for 2 seconds of distribution and 2000 rpm for 5 minutes of drying.

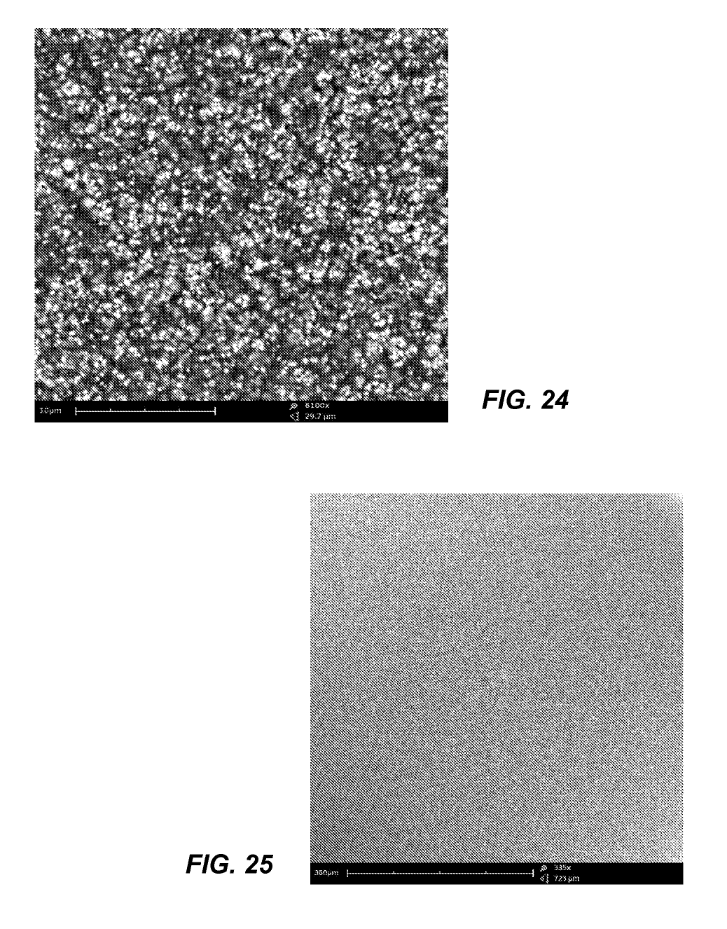

FIG. 24 and FIG. 25 include images of the spin coated layer. As illustrated the spin coated film is a contiguous smooth film without any flaws or breaks and has a thickness of 15 μm.

### Example 5

An electrical energy storage device is configured to include 31,351 components, each including at least 265 elements. The electrical energy storage device's weight, stored energy, volume, and configuration design parameters are illustrated below. In the example, a dielectric ceramic particulate having a relative permittivity (K) of 70,000 is used. Higher relative permittivity particulate and higher voltages can be used.

Energy stored by a capacitor: E=CV²/2 wherein C=capacitance in farads (F) and V=voltage across the terminals of the capacitor. Design parameter for working voltage is V=3500 V

C=∈ₒKA/t

∈ₒ=permittivity of free space
K=relative permittivity of the material
A=area of the energy-storage component layers=0.508 cm×1.143 cm=0.5806 cm²
t=thickness of the energy-storage component layers=10×10⁻⁴ cm

The capacitance of one cell=(8.854×10⁻¹² F/m×70,000×5.806×10⁻⁵ m²/10×10⁻⁶ m)=3.5984 μF. The capacitance of a component (265 element layers) is 953.6

The (E) component=(953.6×10⁻⁶ F*(3500V)²)/(2*3600s/h)=1.624 W·h. For 31,351 components, the capacity is 50.8 kW·h.

Volume and weight is determined for 31,351 components. The volume of the dielectric layer is 0.5806 cm²×10×10⁻⁴ cm=0.0005806 cm³. The weight of the alumina-coated composition-modified barium titanate powder=(0.0005806 cm³×265×31,351×6.5 g/cm³×0.94/1000)=29.47 kg for a composition including 94% of the ceramic powder. The weight of the poly(ethylene terephthalate) powder=(0.0005806 cm³×265×31,351×1.4 g/cm³×0.06/1000)=0.405 kg, assuming 6% PET in the composition.

For electrodes, the electrode layer thickness is 1.0×10⁻⁵ m. The volume of the electrode is 0.5806 cm²×1×10⁻³ cm=5.806×10⁻⁴ cm³. The weight of the aluminum powder for the electrodes=(5.806×10⁻⁴ cm³×265×31,351×2.7 g/cm³/1000)=13.02 kg.

Assuming 15 kg in additional weight from packaging and circuits, the total weight is approximately 42.9 kg. The total volume, assuming volume for connections and packing volume, is 24.02 liters. Thus, the specific energy expressed in terms of weight is 1.2 kW·h/kg and the energy density expressed in terms of volume is 2.099 kW·h/liter or over 4.0 kW·h/liter without packaging.

For smaller systems or systems in which packaging utilizes less volume, the volume occupied by the capacitive devices is a greater percentage of the overall systems. For example, smaller devices may include not greater than 10% of the volume for packaging, leaving at least 90% of the space for the capacitive devices and associated interconnections. In medium size devices, the volume for packaging may occupy in the range of 10% to 20%. In larger size devices, the volume of the packaging may occupy around 20% to 30% of the device. For this reason, energy density for the purposes of the claims is determined absent packaging, but including the capacitive elements and interconnections between the elements. Similarly, the voltage used in determining specific energy or energy density is the breakdown voltage of the device measured at room temperature and the capacitance is measured at room temperature.

In a particular embodiment, the electrical energy storage unit can be used to replace aluminum electrolytic capacitors. As described above, the electrical ESU can be based on components fabricated with composition-modified barium titanate powders immersed in a polymer that form the dielectric layer deposited onto anode/cathode layers. Such anode/cathode layers are stacked on-top of each other until the specified number of layers is achieved. The number of layers contributes to the capacitance, which provides the energy storage of the components. The component end caps can be attached using tin/silver soldering to printed circuit boards and can be closely packed to assist in providing the last stage for fabricating high energy density electrical ESUs. The number of layers can be one or many thousands depending on the application.

On the other hand, aluminum electrolytic capacitors provide relatively lower energy storage. For example, an EPCOS aluminum electrolytic capacitor (Part number: B435*4B6478M00#) reports the parameters in Table 3 below.

TABLE 3
Parameters for EPCOS Aluminum Electrolytic Capacitor

| Parameter | Value |
|---|---|
| Voltage rating: | 500 V dc |
| Capacitance: | 4700 μF @ 100 Hz @ 20° C. |
| Price: | $259.43 @ Quantity = 20 |
| Case Dimensions: | d = 91 mm, l = 144.5 mm |
| Volume: | 1.88 L |
| Mounting type | Screw type lugs |
| Stored Energy | 163 × 10⁻³ W · h/kg |
| Energy Density: | 0.532 W · h/L |
| Life expectance | 1 to 2 years |

In contrast, when designed with a similar capacitance as the EPCOS aluminum electrolytic capacitor, part number B435*4B6478M00# identified above, a capacitor developed using the present CMBT powders can have the properties illustrated in Table 4 below.

TABLE 4
Parameters for Exemplary Electrical ESU

| Parameter | Value |
|---|---|
| Voltage rating: | 3500 V dc |
| Capacitance: | 4700 μF @ 100 Hz @ 20° C. |
| Case Dimensions: | 3.175 cm × 3.175 cm |
| Volume: | 4.371 × 10⁻³ L |
| Mounting type | Flip chip onto PC boards |
| Stored Energy | 7.99 W · h/kg |
| Energy Density: | 1829.5 W · h/L |
| Life expectance | >20 years |

Such a technical comparison between aluminum electrolytic and electrical ESU ceramic capacitors demonstrates a significant improvement that such advancement can bring to multiple business segments. In particular, the advantages of electrical ESUs over aluminum electrolytic capacitor manufactured by EPCOS include an 85.7% increase in working voltage, a 99.77% reduction in volume, flip-chip mounting of electrical ESUs to provide a significant reduction in required product space, and a 99.7% increase in energy density. Such improved electrical ESUs can have utility as power cells for portable tools, storage for grid load leveling, power supplies for electric or hybrid vehicles, energy storage for computers and handheld devices, uninterruptable power supplies, storage for energy acquired through alternative energy technologies, such as wind and solar technologies, energy delivery stations, HE/V capacitors, or applications for militaries or space agencies, such as National Aeronautics and Space Administration. While several industries and applications are described above, electrical ESUs can be used in a variety of industries and applications

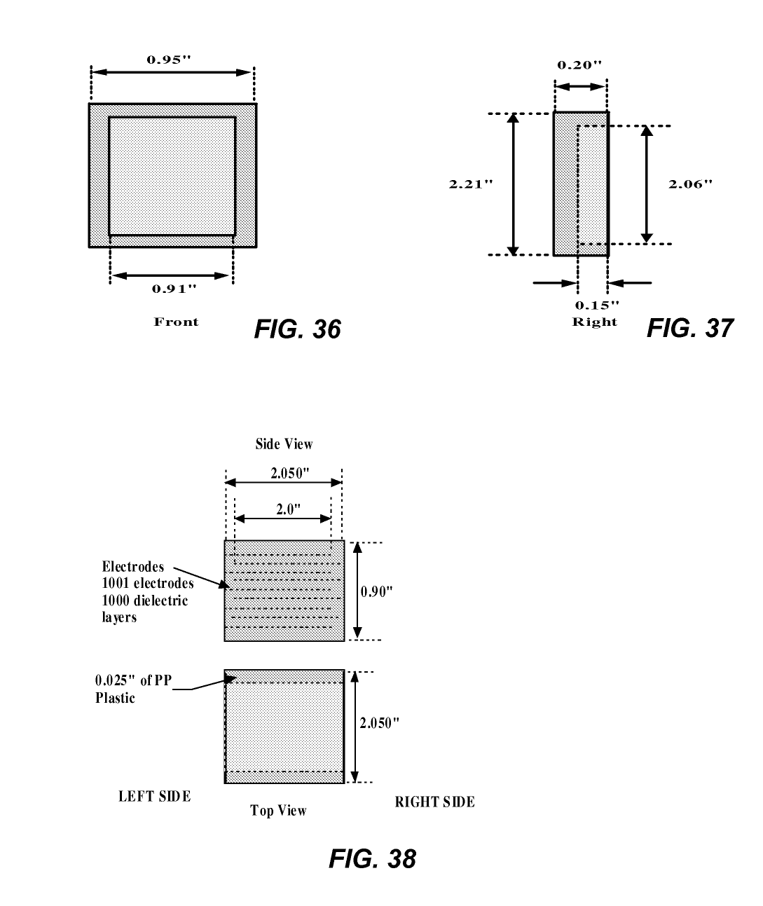

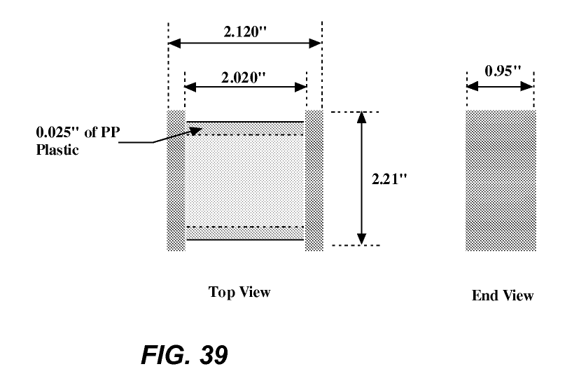

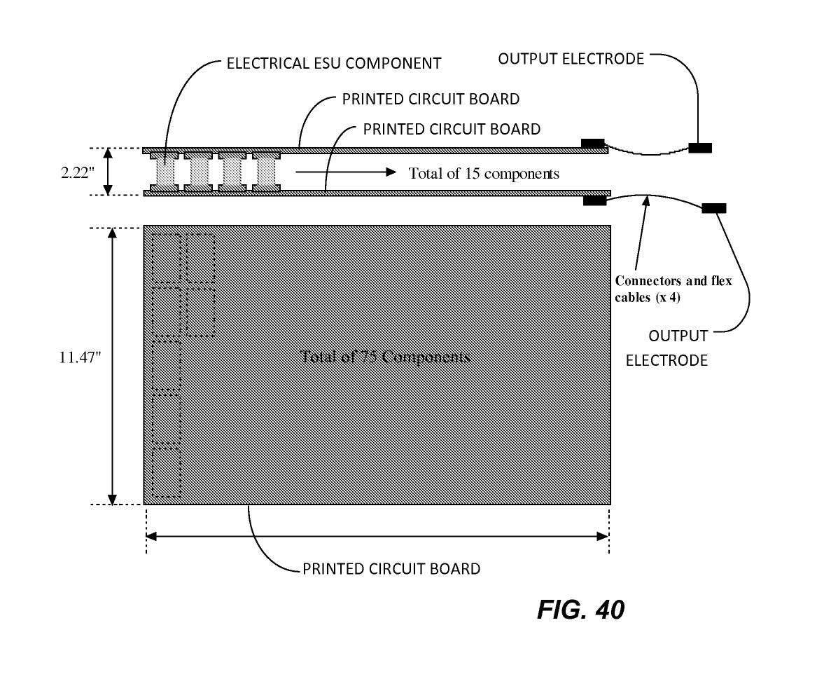

Having described some particular examples, some particular applications using electrical ESUs are described. Converter circuits can be utilized to charge the electrical ESU or deliver power (energy) to the user from the electrical ESU fabricated using capacitors as indicated above and high density packaged onto printed circuit boards. The charging method can also be performed with the use of specialized circuits hooked up to power sources, such as the utility grid standard 115 V or 220 V 60 hertz outputs or special energy sources, such as electrical ESU to electrical ESU with proper hook-up circuitry, motor generators, photovoltaic systems, wind turbine systems, or fuel cells. Such a list represents a partial set of energy sources and many other types of energy sources can be utilized to provide energy to an electrical ESU. Additional examples of components, electrical ESU layers, and electrical ESU external configurations are illustrated in FIG. 36 through FIG. 41.

In a particular example, the energy density of an electrical ESU can be at least 854 W·h/L or higher and the specific energy can be at least 560 W·h/kg or higher. Table 5 illustrates a comparison of an exemplary electrical ESU and three battery technologies. The electrical ESU exhibits improved properties relative to the battery technologies.

TABLE 5
Comparison of electrical ESUs and Battery Technologies

| | Electrical | | LA | |
|---|---|---|---|---|
| | ESU | NiMH | (Flow Gel) | Lithium Ion |
| Weight | 300 | 1700 | 3600 | 880 |
| (pounds) | | | | |
| Volume (ft³) | 2.6 | 10 | 26 | 6.4 |
| Discharge rate | 0.02%/30 | 5%/30 days | 1%/30 days | 1%/30 days |
| | days | | | |
| Charge time | *3 to 6 min | 6.0 hr (80%) | 8 to 15 hr | 6.0 hr (80%) |
| | (100%) | | (80%) | |
| Energy density | 852 W · h/L | 222 W · h/L | 82 W · h/L | 346 W · h/L |
| Life reduced | None | Moderate | High | Moderate |
| with deep cycle | | | | |
| use | | | | |
| Storage | Negligible | High | Very High | High |
| capacity | | | | |
| reduction with | | | | |
| temperature | | | | |
| Hazardous | None | Yes | Yes | Yes |
| materials | | | | |

*Charge and discharge rates are set by the electrical ESU converter circuits and the energy delivery capability of the charging units

Further, the electrical ESU can be used in various circuits to store and provide power.

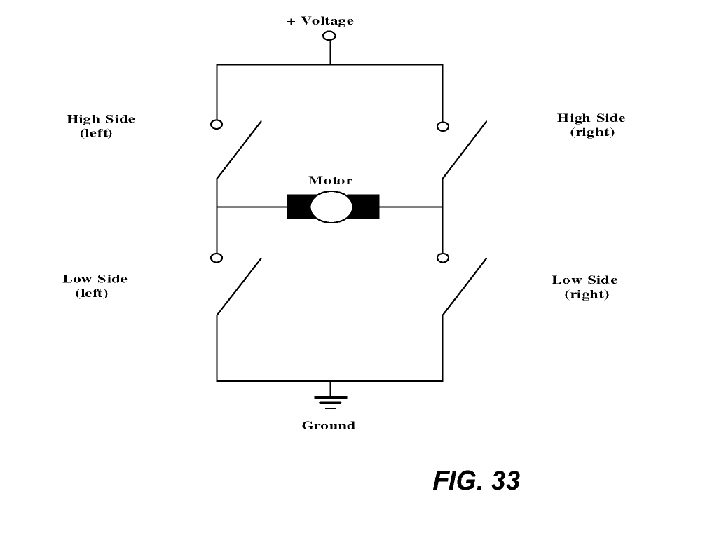

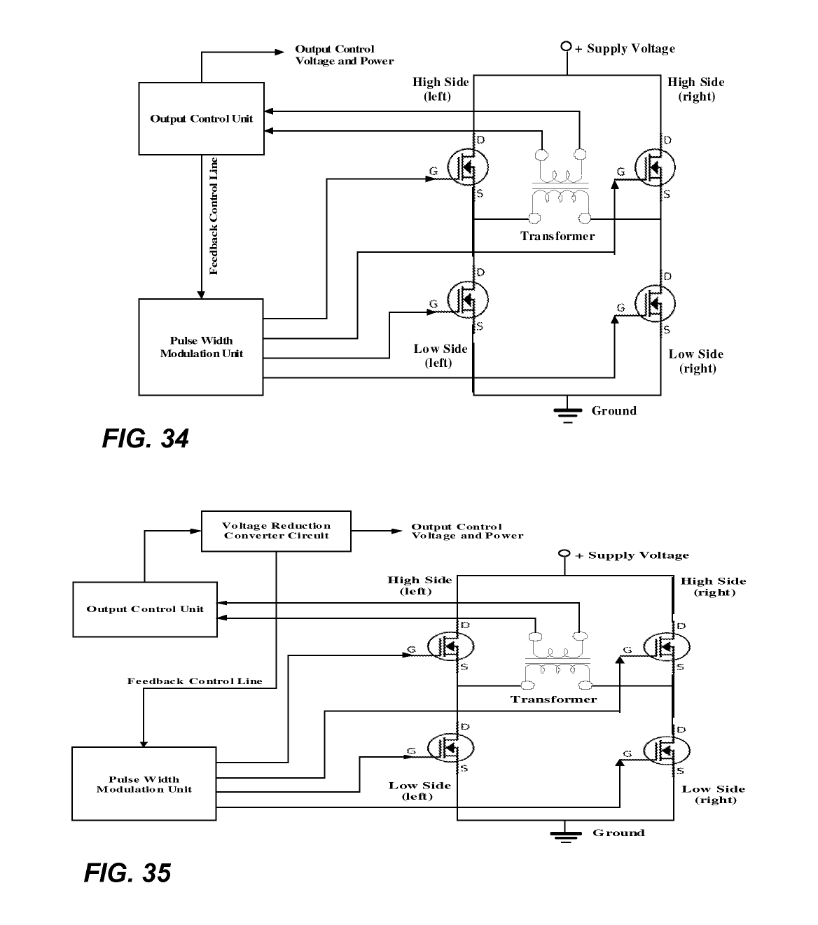

The H-bridge is sometimes called a “full bridge.” The H-bridge is so named because it has four switching elements at the “corners” of the H and the motor forms the cross bar. The basic bridge is illustrated in FIG. 33. As illustrated, there are four switching elements within the bridge, often designated high side left, high side right, low side right, and low side left when enumerated in clockwise order starting at the top left.

The switching elements are turned on in pairs, either high left and lower right, or lower left and high right, but not both switching elements on the same side (left or right) of the bridge. If both switching elements on one side of a bridge are turned on it creates a short circuit between the positive and negative terminals of the power supply referred to as shoot through. If the components of the bridge have adequate ratings, the bridge permits shoot through and the power supply drains quickly. Usually, however, the switching elements fail.

To power the motor, two switching elements that are diagonally opposed are turned on. As illustrated, the two active switching elements are the high side left and low side right switches and the motor turns in the positive direction. If the high side right and low side left switches are one, the motor rotates in the opposite direction. Table 6 illustrates and exemplary configuration.

TABLE 6
Switching Element Configurations

| High | | Lower | | Motor |
|---|---|---|---|---|
| Left | High Right | Left | Lower Right | Direction |
| On | Off | Off | On | Clockwise |
| Off | On | On | Off | Counter |
| | | | | Clockwise |

If at least three of the switching elements are off, the motor is off.

In another example illustrated in FIG. 34, the motor can be replace be with a transformer having a primary coil and a secondary coil. The output of the secondary coil of the transformer is set by the turn ratio to a specified step down voltage, which is used to power an output control unit. A pulse width modulation unit controls the switching elements, including the high side left, high side right, lower left, and lower right switching elements. The pulse width modulation unit can influence power output by changing the pulse width of signals controlling the switches. The output control unit also provides feedback to a pulse width modulation unit to assist in providing a regulated output voltage as the output power is varied by the users power load demand. The pulse width modulation circuitry can change the pulse width or other characteristics of the signal based on input from the control unit. For example, when the supply voltage is +3500 V, the output voltage of the output control unit can be in the range of +900 V to +350V. A wider output voltage range can be provided for applications using higher or lower output voltages. The supply voltage can be supplied by an electrical ESU.

When lower output voltages are desired, a voltage reduction converter circuit can be added, as indicated in FIG. 35. Such a voltage reduction converter circuit has the capability to reduce the voltage to a lower specified value. In a particular example, the output voltage can be set in the range of +150 V to +5 V. A wider output voltage range can be provided when the application utilizes higher or lower output voltages. The supply voltage can be supplied by an electrical ESU.

In a further example, electrical ESUs can be used in various circuitries, some of which can be bidirectional. Exemplary converter circuit architectures include switching buck converter, switching boost converter, buck-boost converter, forward converter, fly back converter, Cuk converter, half-bridge converter, full-bridge converter, LLC-bridge converter, phase shift full-bridge converter, phase shift half-bridge converter, dual half-bridge converter, push-pull converter, DC to 3 phase AC converter, or other bidirectional converters. The switching elements can be selected to carry a current sufficient to provide the desired output. In an example, high voltage MOSFET transistors are used.

An exemplary configuration of an electrical ESU and related components is illustrated in FIG. 36 through FIG. 41. While the component, electrical energy storage layers, and electrical energy storage unit configurations are illustrated with particular dimensions, such configurations represent only a partial set of possible configurations and many acceptable configurations can be employed as utilized in different capacitor packaging and printed board fabrication techniques. Further, larger or smaller energy storage components, electrical energy layers, or electrical energy storage units can be configured depending on the application.

As illustrated in FIG. 38, a component includes stacks of electrodes and dielectric layers. Alternating electrodes are off-set in the stack to allow electrodes to be connected in parallel after the end caps are installed. In an example, the components can be injection molded with a polymer, such as polypropylene to reduced edge fringing and provide component strength. In an example, the left and right sides can be trimmed to expose the electrodes off-set toward the left and right sides, respectively. An end cap can be installed on the left and right sides to connect to alternating electrodes. The alternating electrodes are connected in parallel mode. FIG. 36 and FIG. 37 illustrate exemplary end caps. The number of layers can be increased or decreased depending on the application. The electrode material can be copper, aluminum, or any combination thereof. As illustrated, the electrode and the dielectric layer thicknesses are 10 micrometers, but can be modified to meet other application specifications. The area and thickness can be changed for different application specifications.

FIG. 39 illustrates an electrical ESU component with end caps attached. As illustrated, the component can provide an energy density of 1224 W·h/L, a total energy of 47.5 W·h, a volume of 0.03883 L, a capacitances of 27920 μF per 1000 layers. Alternatively, the number of layers can be adjusted to meet Yasakwa ratings. For example, 193 layers provides 5400 μF, 172 layers provides 4800 μF, 104 layers provides 2900 μF, 79 layers provides 2200 μF, or 36 layers provides 1000 μF.

Such electrical ESU components can be connected in an array to printed circuit boards. An array of electrical ESU components is arranged in a single layer and attached to upper and lower printed circuit boards. For example, the single layer can be a two-dimensional pattern including electrical ESU components arranged in rows and columns. The printed circuit boards can be connected to output electrodes using connectors, such as flexible cables. In particular, the electrical ESU components can be connected to the printed circuit boards with solder, such as tin/silver solder. The printed circuit boards can have fusible links that provide short circuit protection. The number of electrical ESU components can be varied to provide the desired storage capacity. For example, the array can include at least 50 electrical ESU components, such as at least 75 electrical ESU components, at least 100 electrical ESU components, at least 150 electrical ESU components or even at least 300 electrical ESU components. In particular, the electrical ESU can be configured to have a total weight in a range of 100 lbs to 500 lbs, such as 200 lbs to 400 lbs, or even 250 lbs to 350 lbs, or approximately 300 lbs. A particular embodiment as illustrated in FIG. 14 includes 75 electrical ESU components connected to printed circuit boards that are connected to output electrodes.

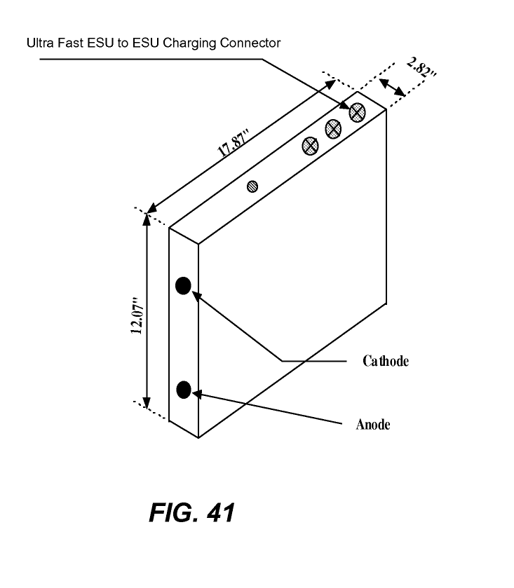

In a further example illustrated in FIG. 41, the electrical ESU can have separate charging and discharging electrodes. For example, the electrical ESU can have an output cathode and anode. In an example, the output voltage and power can be selected by the user. Exemplary voltages (e.g., voltage different between the output anode and the output cathode) can range from 900 V to 5 V dc. An exemplary electrical ESU can have an output power of 1500 W to 3000 W or can be as high as 600 kW or higher. The output power can be restricted by converter circuits. Additional output electrodes can be provided and connected to internal output control circuits to provide different output voltages.

As illustrated, the electrical ESU has a volume of 9.967 L and includes 150 electrical ESU components. The converter and control circuits have a volume of 0.897 L. The energy density can be 7145 W·h/L and the storage can be 7125 W·h. The box material can be metallic, such as 316L stainless steel, aluminum, or titanium and can be hermetically sealed with clean dry air contained in the box. Shock protection can be provided by a 0.25 inch rubber padding that has a desirable durometer and that surrounds the energy storage array and circuits. Shock protection can be increased to meet the user application or Underwriters Laboratories safety specifications.

In a further example, the electrical ESU includes charging connectors that are separate from the output electrodes. Such charging connectors can permit faster input of electrical energy, such as using high current or high voltage. The charge connectors can be electrically connected to the electrical ESU components to permit quick charging of the components without activating fusible links. Such quick charging can be accomplished by using at least three input electrodes, such as at least 4, at least 6, or even at least 8 input electrodes. Alternatively, internal circuitry can be provided to permit quick charging. In a further embodiment, sets of input electrodes can be provide, one set for quicker charging and another set for slower recharging. For example, a set of electrodes can be provided for low voltage high current recharge and a second set can be provided for high voltage low current recharge.

Exemplary circuits such as those described above can use such electrical ESUs to reduce high voltages to lower working voltages that are highly regulated over a wide range of output power demands. Such circuit components and modules or the overall architecture provide a function that meets wide user demands over a many types of products such as portable tools, portable computers and hand held units, UPS systems, electric vehicles, and military systems. Such a wide usage over a broad product spectrum and the capability to effectively reduce the voltage to meet such product demands provide a desirable product.

Many different aspects and embodiments are possible. Some of those aspects and embodiments are described herein. After reading this specification, skilled artisans will appreciate that those aspects and embodiments are only illustrative and do not limit the scope of the present invention. Additionally, those skilled in the art will understand that some embodiments that include analog circuits can be similarly implemented using digital circuits, and vice versa.

In a first aspect, a power supply can include an electrical energy storage unit including a capacitive element and having an output electrode. The power supply can also include a transformer including a primary coil and a secondary coil, the primary coil having first and second electrodes, the second coil providing first and second output electrodes. The power supply can further include first, second, third, and fourth switching elements. A first side of the first and second switching elements can be connected to the output electrode of the electrical energy storage unit, a second side of the first switching element can be connected to the first electrode of the primary coil, and a second side of the second switching element can be connected to the second electrode of the primary coil. A first side of the third and fourth switching elements can be connected to ground, a second side of the third switching element can be connected to the first electrode of the primary coil, and a second side of the fourth switching element can be connected to the second electrode of the primary coil. The power supply can further include a pulse width modulation unit to control the first, second, third and fourth switching elements.

In an embodiment of the first aspect, the power supply=further includes an output control unit connected to the first and second output electrodes of the second coil, the output control unit to provide power to a load. In a particular embodiment, the output control unit is coupled to the pulse width modulation unit to provide feedback. In another particular embodiment, the power supply further includes a voltage reduction converter circuit electrically connected between the output control unit and the load.

In a second aspect, an power supply can include a plurality of storage components, each storage component including a capacitive element and having a first electrode and a second electrode. The power supply can also include a first and second printed circuit boards, the first electrode of each of the plurality of storage components connected to the first printed circuit board, and the second electrode of each of the plurality of storage components connected to the second printed circuit board.

In an embodiment of the second aspect, the power supply further includes a first output electrode electrically connected to the first printed circuit board. In a particular embodiment, the power supply further includes a second output electrode electrically connected to the second printed circuit board. In another embodiment, the first circuit board includes a fusible link. In a further embodiment, the plurality of storage components is arranged in a two-dimensional pattern. In a particular embodiment, the two-dimensional pattern includes rows and columns.

In a third aspect, a power supply can include a storage component including a capacitive element, an output anode electrically connected to the storage component, an output cathode electrically connected to the storage component, and an input electrode electrically connected to the storage component.

In an embodiment of the third aspect, the input electrode is one of a plurality of input electrodes, the plurality of input electrodes including at least three electrodes. In another embodiment, the input electrode is electrically connected to the storage component to permit higher current flow to the storage component than permitted through the output anode and cathode without activating a fuse. In still another embodiment, the input electrode is one of a first set of input electrodes, the power supply further includes a second set of input electrodes, the first set to permit input of a higher current than the second set without activating a fuse. In a particular embodiment, the second set is to permit input of a higher voltage than the first set without activating a fuse. In another particular embodiment, the power supply further includes a second output anode, a second output cathode, and output control circuitry, the output control circuitry to provide a higher voltage to the output anode and cathode than the second output anode and cathode. In a further embodiment, the output anode is along a first side of the power supply, the output cathode is along a second side of the power supply, the input electrode is along a third side of the power supply, wherein the third side is immediately adjacent to the first side or the second side. In a particular embodiment, the first side and the second side are a same side.

In a fourth aspect, a power control circuitry can include a transformer including a primary coil and a secondary coil, the primary coil having first and second electrodes, the second coil providing first and second output electrodes. The power control circuitry can also include first, second, third, and fourth switching elements. A first side of the first and second switching elements can be connected to the output electrode of the electrical energy storage unit, a second side of the first switching element can be connected to the first electrode of the primary coil, and a second side of the second switching element can be connected to the second electrode of the primary coil. The power control circuit can further include a pulse width modulation unit to control the first and second switching elements, and an output control unit connected to the first and second output electrodes of the second coil, the output control unit connected to the pulse width modulation unit to control the pulse width modulation unit.

In an embodiment of the fourth aspect, the power control circuitry further includes third and fourth switching elements, a first side of the third and fourth switching elements connected to ground, a second side of the third switching element connected to the first electrode of the primary coil, and a second side of the fourth switching element connected to the second electrode of the primary coil. In a particular embodiment, the pulse width modulation unit is to control the third and fourth switching elements. In another embodiment, the pulse width modulation unit is to change the pulse width of a signal controlling the first and second switching units based on communication from the output control unit.

Note that not all of the activities described above in the general description or the examples are required, that a portion of a specific activity may not be required, and that one or more further activities may be performed in addition to those described. Still further, the orders in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

What claimed is:

1. A power supply comprising:
an electrical energy storage unit including a capacitive element and having an output electrode;
a transformer including a primary coil and a secondary coil, the primary coil having first and second electrodes, the second coil providing first and second output electrodes;
first and second switching elements, a first side of the first and second switching elements connected to the output electrode of the electrical energy storage unit, a second side of the first switching element connected to the first electrode of the primary coil, and a second side of the second switching element connected to the second electrode of the primary coil;
third and fourth switching elements, a first side of the third and fourth switching elements connected to ground, a second side of the third switching element connected to the first electrode of the primary coil, and a second side of the fourth switching element connected to the second electrode of the primary coil; and
a pulse width modulation unit to control the first, second, third and fourth switching elements.

2. The power supply of claim 1, further comprising an output control unit connected to the first and second output electrodes of the second coil, the output control unit to provide power to a load.

3. The power supply of claim 2, wherein the output control unit is coupled to the pulse width modulation unit to provide feedback.

4. The power supply of claim 2, further comprising a voltage reduction converter circuit electrically connected between the output control unit and the load.

5. An power supply comprising:
a plurality of storage components, each storage component including a capacitive element and having a first electrode and a second electrode; and
a first and second printed circuit boards, the first electrode of each of the plurality of storage components connected to the first printed circuit board, and the second electrode of each of the plurality of storage components connected to the second printed circuit board.

6. The power supply of claim 5, further comprising a first output electrode electrically connected to the first printed circuit board.

7. The power supply of claim 6, further comprising a second output electrode electrically connected to the second printed circuit board.

8. The power supply of claim 5, wherein the first circuit board includes a fusible link.

9. The power supply of claim 5, wherein the plurality of storage components are arranged in a two-dimensional pattern.

10. The power supply of claim 9, wherein the two-dimensional pattern includes rows and columns.

11. A power supply comprising:
a storage component including a capacitive element;
an output anode electrically connected to the storage component;
an output cathode electrically connected to the storage component; and
an input electrode electrically connected to the storage component.

12. The power supply of claim 11, wherein the input electrode is one of a plurality of input electrodes, the plurality of input electrodes including at least three electrodes.

13. The power supply of claim 11, wherein the input electrode is electrically connected to the storage component to permit higher current flow to the storage component than permitted through the output anode and cathode without activating a fuse.

14. The power supply of claim 11, wherein the input electrode is one of a first set of input electrodes, the power supply further comprising a second set of input electrodes, the first set to permit input of a higher current than the second set without activating a fuse.

15. The power supply of claim 14, wherein the second set is to permit input of a higher voltage than the first set without activating a fuse.

16. The power supply of claim 14, further comprising a second output anode, a second output cathode, and output control circuitry, the output control circuitry to provide a higher voltage to the output anode and cathode than the second output anode and cathode.

17. The power supply of claim 11, wherein:
the output anode is along a first side of the power supply;
the output cathode is along a second side of the power supply;
the input electrode is along a third side of the power supply, wherein the third side is immediately adjacent to the first side or the second side.

18. The power supply of claim 17, wherein the first side and the second side are a same side.

19. A power control circuitry comprising:
a transformer including a primary coil and a secondary coil, the primary coil having first and second electrodes, the second coil providing first and second output electrodes;
first and second switching elements, a first side of the first and second switching elements connected to the output electrode of the electrical energy storage unit, a second side of the first switching element connected to the first electrode of the primary coil, and a second side of the second switching element connected to the second electrode of the primary coil;
a pulse width modulation unit to control the first and second switching elements; and
an output control unit connected to the first and second output electrodes of the second coil, the output control unit connected to the pulse width modulation unit to control the pulse width modulation unit.

20. The power control circuitry of claim 19, further comprising third and fourth switching elements, a first side of the third and fourth switching elements connected to ground, a second side of the third switching element connected to the first electrode of the primary coil, and a second side of the fourth switching element connected to the second electrode of the primary coil.

21. The power control circuitry of claim 20, wherein the pulse width modulation unit is to control the third and fourth switching elements.

22. The power control circuitry of claim 19, wherein the pulse width modulation unit is to change the pulse width of a signal controlling the first and second switching units based on communication from the output control unit.
